(19) United States
(12) Patent Application Publication
(10) Pub. No.: US 2016/0300214 A1
(43) Pub. Date: Oct. 13, 2016

(54) METHODS AND SYSTEMS FOR AUTOMATED MATTER RESOLUTION

(71) Applicants: Elizabeth Chaffin, Tracy, CA (US); David Richey, Hayward, CA (US); Richard Stopic, Singapore (SG); Stacey Jess, Byron, CA (US)

(72) Inventors: Elizabeth Chaffin, Tracy, CA (US); David Richey, Hayward, CA (US); Richard Stopic, Singapore (SG); Stacey Jess, Byron, CA (US)

(21) Appl. No.: 15/093,257

(22) Filed: Apr. 7, 2016

Related U.S. Application Data
(60) Provisional application No. 62/144,784, filed on Apr. 8, 2015.

(51) Int. Cl. G06Q 20/22

(52) U.S. Cl. CPC G06Q 20/22; G06Q 50/182

(57) ABSTRACT

Embodiments of the invention are directed to transaction dispute resolution system that uses a liability model for resolving disputes. Disputed claims may be validated based on transaction information and according to predefined validation rules. A validated dispute claim may be processed according to a claim category of the dispute claim. An automated liability allocation process is used to process a dispute claim that requires little or no additional information whereas a collaboration process is used to process a dispute claim that requires additional information provided by parties of the claim. The automated liability allocation process may be based on dispute history information of the parties of the claim.

### CROSS-REFERENCES TO RELATED APPLICATIONS

The present application is a non-provisional and claims the benefit of priority to U.S. Provisional Application 62/144,784, filed on Apr. 8, 2015 (Attorney Docket No.: 079900-0940002), which content is hereby incorporated in its entirety for all purposes.

### SUMMARY

Current methods for resolving transaction dispute claims in the electornic payments industry are slow, expensive, and complicated. Currently, when a holder of a credit card account disputes a transaction (e.g., by alleging that a charge on his credit card statement is fraudulent), the holder notifies his issuer. The issuing bank can then initiate a dispute with the merchant that conducted the transaction through the merchant's acquirer. Currently, a “litigation” model is used where an intermediary such as a payment processing organization adjudicates the dispute. Timelines for response are set, and each party (e.g., issuer and acquirer) can provide arguments or evidence to support their case. The intermediary then decides which party is responsible for the disputed transaction. Manual analyses and extensive communications with involved parties are required, and the process can be burdensome.

Embodiments of the present invention address these problems and other problems, individually and collectively.

One embodiment of the invention is directed to a computer-implemented method. The method comprises receiving, by a computer, a dispute claim regarding a disputed transaction and transaction information about a disputed transaction; obtaining, by the computer, a plurality of dispute performance indicators respectively associated with a plurality of parties of the disputed transaction, the dispute performance indicators generated based at least in part on dispute histories respectively associated with the parties; and automatically determining, by the computer, an allocation of liabilities among the plurality of parties based at least in part on the transaction information and the dispute performance indicators.

Another embodiment of the invention is directed to a computer system. The computer system comprises a memory that stores one or more computer-executable instructions, and a processor configured to access the memory and execute the computer-executable instructions to implement a method. The method comprises: receiving a dispute claim regarding a disputed transaction and transaction information about a disputed transaction; obtaining a plurality of dispute performance indicators respectively associated with a plurality of parties of the disputed transaction, the dispute performance indicators generated based at least in part on dispute histories respectively associated with the parties; and automatically determining an allocation of liabilities among the plurality of parties based at least in part on the transaction information and the dispute performance indicators.

Another embodiment of the invention is directed to a computer-implemented method. The method comprises: receiving, a computer, a dispute claim regarding a disputed transaction, the dispute transaction associated with a claim category; selecting, by the computer, a resolution process from a plurality of predetermined processes comprising at least an automated liability allocation process and a collaborative dispute resolution process based at least in part on the claim category; and processing, by the computer, the dispute claim using the selected resolution process to determine an allocation of liabilities among at least two parties associated with the dispute claim.

Another embodiment of the invention is directed to a computer system. The computer system comprises a memory that stores one or more computer-executable instructions, and a processor configured to access the memory and execute the computer-executable instructions to implement a method. The method comprises: receiving, a computer, a dispute claim regarding a disputed transaction, the dispute transaction associated with a claim category; selecting, by the computer, a resolution process from a plurality of predetermined processes comprising at least an automated liability allocation process and a collaborative dispute resolution process based at least in part on the claim category; and processing the dispute claim using the selected resolution process to determine an allocation of liabilities among at least two parties associated with the dispute claim.

Further details regarding embodiments of the invention can be found in the Detailed Description and the Figures.

### BRIEF DESCRIPTION OF THE DRAWINGS

FIG. 1 shows system for resolving disputes, in accordance with embodiments.

FIG. 2 shows a flow diagram of an exemplary dispute claim resolution process, in accordance with embodiments.

FIG. 3 shows another flow diagram of another exemplary dispute claim resolution process, in accordance with embodiments.

FIG. 4 shows an exemplary flow diagram for a transaction inquiry process, in accordance with embodiments.

FIG. 5 shows an exemplary flow diagram of an overall process for dispute performance indicators (also referred to as indices) of participants in a dispute, in accordance with embodiments.

FIG. 6 shows an exemplary flow diagram of a process for determining a dispute performance indicator (index) associated with a cardholder, in accordance with embodiments.

FIG. 7 shows an exemplary flow diagram of a process for determining a dispute performance indicator (index) associated with an issuer, in accordance with embodiments.

FIG. 8 shows an exemplary flow diagram of a process for determining a dispute performance indicator (index) associated with an acquirer, in accordance with embodiments.

FIG. 9 shows an exemplary flow diagram of a process for determining a dispute performance indicator (index) associated with a merchant, in accordance with embodiments.

FIG. 10 shows three types of indices that may be associated with various participants, in accordance with embodiments.

FIG. 11 shows exemplary data that can be used to allocate liability among participants of a disputed transaction, in accordance with embodiments.

FIG. 12 shows an exemplary flow diagram of a process for processing claims related to fraud, in accordance with embodiments.

FIG. 13 shows an exemplary flow diagram of a process for processing claims related to authorization errors, in accordance with embodiments.

FIG. 14 shows an exemplary collaboration process between an acquirer and an issuer, in accordance with embodiments.

FIG. 15 shows another exemplary flow diagram of a collaboration process between an issuer and an acquirer, in accordance with embodiments.

FIG. 16 shows an exemplary collaboration flow diagram of a process where evidence is required to determine a resolution, in accordance with embodiments.

FIG. 17 shows an exemplary flow diagram of a collaboration process where the acquirer elects not to respond to a formal collaboration request from an issuer, in accordance with embodiments.

FIG. 18 shows another exemplary flow diagram of a collaboration process, in accordance with embodiments.

FIG. 19 shows an exemplary flow diagram of a collaboration process where the issuer withdraws the collaboration request, in accordance with embodiments.

FIG. 20 shows an exemplary flow diagram of a collaboration process, in accordance with embodiments.

FIG. 21 shows an exemplary flow diagram of a collaboration process for information request as initiated by a payment processing network, in accordance with embodiments.

FIG. 22 shows data schema for tracking a collaboration process, in accordance with embodiments.

FIG. 23 shows an exemplary merchant profile hierarchy, in accordance with embodiments.

FIG. 24 shows an exemplary flow diagram of an appeal process, in accordance with embodiments.

### DETAILED DESCRIPTION

Prior to discussing specific embodiments of the invention, some terms may be described in detail.

“Transaction information” may include any suitable information that might be present during a transaction. It may include information about the conditions such as the circumstances or settings in which the transaction took place, how the transaction was conducted, or any other suitable information. For example, transaction information may include where and when the transaction took place, as well as who were the involved parties. Transaction information may also include information about what tools and apparatuses were involved, such as details about the payment instrument used by the consumer, what type of access device was used by the merchant, and whether it was an in-person transaction or a card-not-present transaction. Transaction information may also include details about what information was specifically requested by the merchant, and what information was exchanged, such as whether the consumer provided a CVV2, an expiration date, or a signature. Further, transaction information may include information about transaction approval, such as whether or not the transaction was approved, what payment medium was used, what entity authorized the payment information, what information was used to approve or deny the transaction, whether it was an online or offline transaction, etc. Further examples of transaction information are described in the Figures.

An “authorization request message” may be an electronic message that requests authorization for a transaction. In some embodiments, it is sent to a payment processing network and/or an issuer of a payment card to request authorization for a transaction. An authorization request message according to some embodiments may comply with ISO 8583, which is a standard for systems that exchange electronic transaction information associated with a payment made by a consumer using a payment device or payment account. The authorization request message may include an issuer account identifier that may be associated with a payment device or payment account. An authorization request message may also comprise additional data elements corresponding to “identification information” including, by way of example only: a service code, a CVV (card verification value), a dCVV (dynamic card verification value), a PAN (primary account number or “account number”), a user name, an expiration date, etc. An authorization request message may also comprise “transaction information,” such as any information associated with a current transaction, such as the transaction amount, merchant identifier, merchant location, acquirer bank identification number (BIN), card acceptor ID, etc., as well as any other information that may be utilized in determining whether to identify and/or authorize a transaction.

An “authorization response message” may be a message that responds to an authorization request. In some cases, it may be an electronic message reply to an authorization request message generated by an issuing financial institution or a payment processing network. The authorization response message may include, by way of example only, one or more of the following status indicators: Approval-transaction was approved; Decline-transaction was not approved; or Call Center-response pending more information, merchant must call the toll-free authorization phone number. The authorization response message may also include an authorization code, which may be a code that a credit card issuing bank returns in response to an authorization request message in an electronic message (either directly or through the payment processing network) to the merchant's access device (e.g. POS equipment) that indicates approval of the transaction. The code may serve as proof of authorization. As noted above, in some embodiments, a payment processing network may generate or forward the authorization response message to the merchant.

The term “server computer” may include a powerful computer or cluster of computers. For example, the server computer can be a large mainframe, a minicomputer cluster, or a group of servers functioning as a unit. In one example, the server computer may be a database server coupled to a Web server. The server computer may comprise one or more computational apparatuses and may use any of a variety of computing structures, arrangements, and compilations for servicing the requests from one or more client computers.

According to an aspect of the present invention, a dispute resolution system is provided that is configured to validate dispute claims based at least in part on transaction information and according to predefined validation rules.

According to another aspect of the present invention, the dispute resolution system is configured to process a dispute claim according to a claim category of the dispute claim. An automated allocation process is used to process a dispute claim falling under a claim category that requires little or no additional information whereas a collaboration process is used to process a dispute claim falling under a claim category that requires additional information provided by parties of the claim.

According to another aspect of the present invention, an automated allocation process is provided to automatically allocate liabilities among parties of a dispute claim based at least in part on the transaction information and dispute performance indicators of the parties. The dispute performance indicators may be calculated based on data of dispute histories for the parties. The automated allocation process may be governed at least in part by a set of predetermined allocation rules. The allocation rules may be based on transaction data and/or dispute performance data.

According to another aspect of the present invention, a streamlined collaboration process is provided to resolve dispute claims based on at least in part on information provided by parties of the disputed transaction. The collaboration process may be governed at least in part by a set of predetermined collaboration rules. The collaboration rules may be based on transaction data and/or party response timeframe.

According to another aspect of the present invention, merchant access is provided to allow direct access by merchants to aspects of the dispute resolution process.

### System Architecture

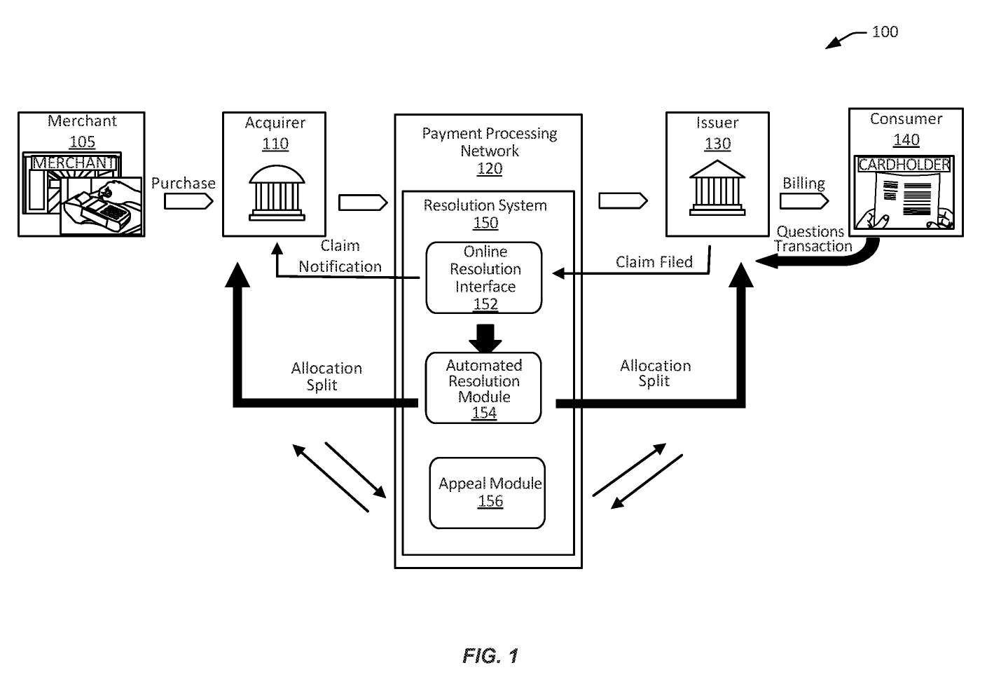

FIG. 1 shows system 100 for resolving disputes, in accordance with embodiments. The system 100 comprises a merchant 105 (which may be an example of a first party) which may be coupled with an access device. The merchant 105 may be in communication with an acquirer 110 and a payment processing network 120. The acquirer 110 may also be in communication with the payment processing network 120. The payment processing network 120 may also be in communication with an issuer 130. The issuer 130 may be in communication with a consumer 140 (which may be an example of a second party) who may be associated with a payment account issued by the issuer 130. The payment processing network 120 may include a resolution system 150. In some embodiments, the resolution system 150 may be separate from the payment processing network 120, but may still be in communication with the payment processing network 120. The resolution system 150 may include an online resolution interface 152, an automated resolution module 154, and an appeal module 156. The resolution system 150 may be in communication with the issuer 130, consumer 140, acquirer 110, and/or merchant 105.

The merchant 105 may sell goods and/or services to the consumer 140. The merchant may accept multiple forms of payment, and may use multiple tools to conduct different types of transactions. For example, the merchant 105 may operate a physical store and use an access device (e.g. a POS terminal) for in-person transactions. The merchant 105 may also sell goods and/or services via a website, and may accept payments over the Internet.

The merchant 105 may request certain types of information from the consumer 140, depending on transaction conditions, such as how the consumer 140 is providing payment. For example, if a consumer 140 is paying with cash, the merchant 105 may only accept bill denominations of $50 or smaller. If the consumer 140 is paying in person with a credit card, the merchant 105 may request that the consumer 140 provide a signature and/or show an ID. If the consumer 140 is making credit card a purchase over the Internet, the merchant 105 may require that the consumer 140 provides a security code (e.g. CVV2).

The acquirer 110 may be associated with the merchant 105, and may manage authorization requests on behalf of the merchant 105. The acquirer 110 may forward an authorization request from the merchant 105 to the payment processing network 120. Further, the acquirer 110 may handle transaction disputes on behalf of the merchant 105. For example, if the resolution system 150 requests information about a disputed transaction, the acquirer 110 may provide the information on behalf of the merchant 105.

The payment processing network 120 may be disposed between (e.g., in an operational sense) an acquirer 110 and an issuer 130. The payment processing network 120 may include data processing subsystems, networks, and operations used to support and deliver authorization services, exception file services, and clearing and settlement services. For example, the payment processing network 120 may comprise a server computer, coupled to a network interface (e.g. by an external communication interface), and a database(s) of information. An exemplary payment processing network may include VisaNet™. Payment processing networks such as VisaNet™ are able to process credit card transactions, debit card transactions, and other types of commercial transactions. VisaNet™, in particular, includes a VIP system (Visa Integrated Payments system) which processes authorization requests and a Base II system which performs clearing and settlement services. The payment processing network 120 may use any suitable wired or wireless network, including the Internet.

The payment processing network 120 may include one or more databases, such as an authorization database. It may include an authorization database, which may contain information related to a payment device and/or a payment account, as well as any other suitable information (such as transaction information) associated with the payment account. It may include a merchant data database, which may contain information related to one or more merchants. The merchant data database may associate a set of merchant transaction information with a set of merchant identification information. Accordingly, if the payment processing network 120 receives an authorization request message comprising merchant transaction information such as an acquirer BIN and/or a card acceptor ID, the payment processing network 120 may be operable to identify the associated merchant identification information such as a name and a location. In some embodiments, the payment processing network 120 may add merchant identification information from merchant data database to an authorization request message before forwarding the message to an issuer 130. The payment processing network 120 and/or issuer 130 may keep a record of authorized transactions, and may store merchant identification information associated with one or more transactions.

The issuer 130 may issue a payment account and an associated payment device to the consumer 140. The issuer 130 may also assess authorization requests received from a merchant 105. Before authorizing a transaction, the issuer 130 may authenticate payment information received in the authorization request, and check that there is available credit or funds in an associated payment account. The issuer 130 may also receive and/or determine a risk level associated with the transaction, and may weigh the risk when deciding whether or not to authorize the transaction. The issuer 130 may return an authorization response to the payment processing network 120.

The issuer 130 may also receive transaction disputes from the consumer 140, and the issuer 130 may then manage the dispute resolution process. For example, the issuer 130 may file a transaction dispute claim with the payment processing network 120 or with the resolution system 150, and the issuer 130 may provide any necessary or requested information, such as a transaction ID, payment account information, additional transaction information, and/or reasons for the dispute. The issuer 130 may credit the consumer's payment account some or all of the disputed transaction amount whether or not the issuer 130 receives a refund from the acquirer 110.

The resolution system 150 may be associated with the payment processing network 120. The resolution system 150 may use a liability model to resolve transaction disputes between, for example, an acquirer 110 and an issuer 130. For example, a consumer 140 may not recognize a charge on a credit card bill, and may request a refund from the issuer 130. The issuer 130 may in turn file a dispute claim with the payment processing network 130 or directly with the resolution system 150. The resolution system 150 may determine whether the consumer 140, issuer 130, acquirer 110, and/or merchant 105 are liable for the disputed transaction. In some embodiments, more than one entity may be found liable for the transaction, and those entities may be required to share the cost of the transaction. After determining which entities are liable for the transaction, the resolution system 150 may inform the acquirer 110 that it may proceed in refunding the issuer 130 some or all of the transaction amount.

The resolution system 150 may include an online resolution interface 152. The online resolution interface 152 may be accessed online, through an electronic interface, or in any other suitable manner. The online resolution interface 152 may receive dispute claims and information related to disputed transactions from the issuer 130, the acquirer 110, or any other suitable entity. In some embodiments, the resolution system 150 may be separate from the payment processing network 120, but the online resolution interface 152 may still be included in the payment processing network 120.

When a dispute claim is filed, the resolution system 150 may locate the transaction information for consideration during the resolution process. In some embodiments, the transaction information may be associated with a transaction ID, and may be stored at the payment processing network 120 or at the resolution system 150.

The resolution system 150 may include an automated resolution module 154 which may be capable of automatically resolving disputed transactions. The automated resolution module 154 may store a set of rules and regulations (or “edits”) for assigning liability to one or more involved parties based on the transaction information. The rules and regulations can be adjusted over time. The automated resolution module 154 may compare the transaction information to the resolution rules and regulations, and condition logic may be used to determine which of the involved parties are liable for the disputed transaction. For example, in some embodiments, there may be a rule that all payments made with a smartcard or chip-card are secure, and therefore the issuer 130 may be found liable for any disputed smartcard transactions, or the dispute may be rejected. In this manner, an automated, dynamic resolution model may assign liability via a set of rules and regulations, providing simple and fast dispute resolution.

The resolution system 150 may also include an appeal module 156 which may be capable of receiving and facilitate the resolution of appeals. For instance, a party that is unsatisfied with a result of the liability allocated by the automated resolution module 154 may initiate an appeal with the appeal module 156 via an interface such as a graphical user interface, a web service interface, or the like. The appeal module 156 may be configured to initiate and facilitate an appeal process based on a submitted appeal, such as prompting pertinent parties to submit evidence, enforcing rules governing the appeal process (e.g., timing requirement), causing generation of an appeal result, and providing the appeal result to the parties. Aspects of the appeal process may be governed by a set of predetermined appeal rules. For instance, an appeal may be initiated only within a predetermined time period (e.g., within 10 days of receiving an assigned liability). Parties may be given a predetermined time period to submit evidence to the appeal module 156 (e.g., 10 days). Evidence may be reviewed for a given period of time (e.g., 10 days), etc.

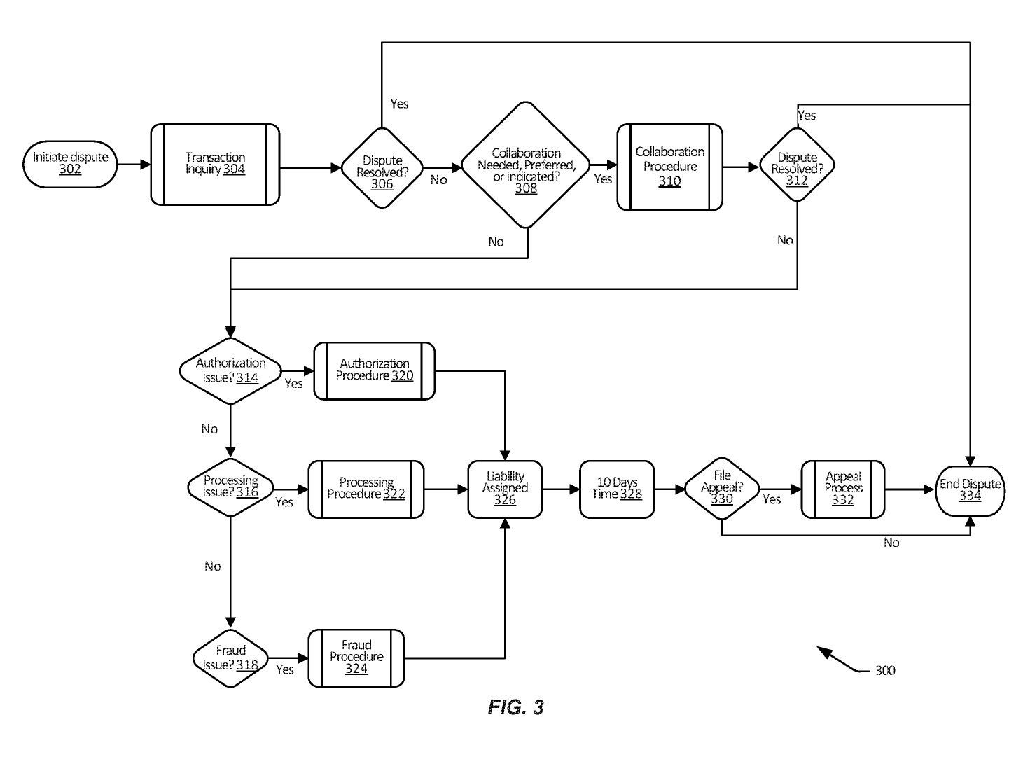

In one example, a consumer 140 may disagree with a charge on an account statement for one or more reasons, and may report the questioned transaction to the issuer 130 of the account. The issuer 130 may proceed by filing a dispute claim with the payment processing network 120 which can use a resolution system 150 to resolve the dispute, or the issuer may 130 may file the dispute claim directly with the resolution system 150. The issuer 130 may file the claim via the online resolution interface 152. The claim may include a transaction ID, payment account information, one or more reasons for the dispute, transaction conditions, and any other suitable information. If specific reasons for disputing the transaction are provided, or if certain types of transaction conditions are known, the resolution module 150 may skip ahead to any part of the process shown in FIG. 3. Other parties such as an acquirer 110, a merchant 105, or a consumer 140 may also file dispute claims.

When the resolution system 150 receives a transaction dispute claim, the resolution system 150 may notify any other parties that are associated with the transaction, such as the acquirer 110, that the dispute claim was filed.

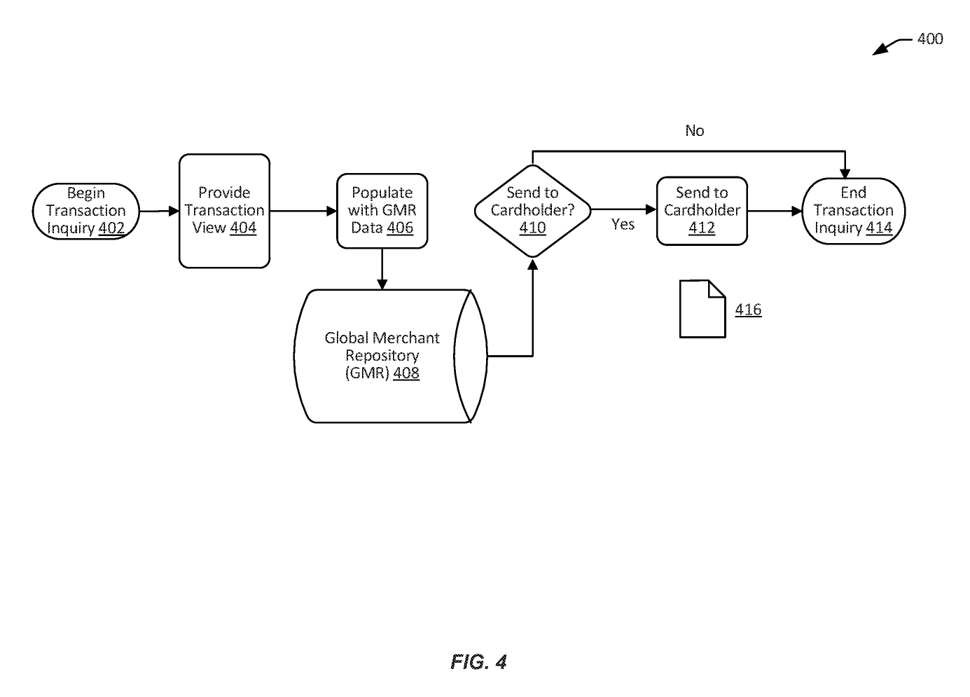

The resolution system 150 may execute a transaction inquiry, and may locate and provide a record of the transaction to the issuer 130 and/or consumer 140. The transaction record may include information about the transaction, information about the parties that were involved in the transaction, and any other suitable information. An exemplary transaction inquiry process is shown in FIG. 4. The consumer 140 may recognize and affirm the transaction, in which case the dispute may be resolved. Alternatively, the consumer 140 and/or issuer 130 may wish to proceed and the resolution process may continue.

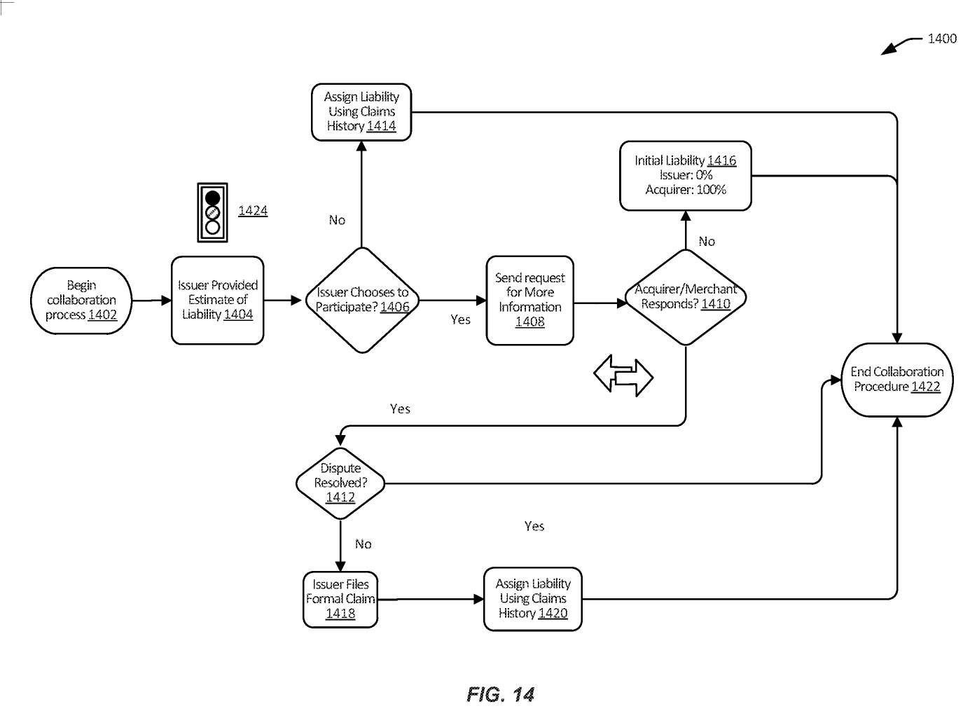

The resolution system 150 may determine whether collaboration is needed to resolve the dispute, or whether one or more involved parties would like to collaboratively resolve the dispute. The issuer 130 and acquirer 120 may then collaboratively resolve the dispute. Alternatively, one or more parties may decide to not collaborate, or the collaboration may not resolve the dispute, and the resolution process may continue. Exemplary collaboration procedures are shown in FIGS. 14-21.

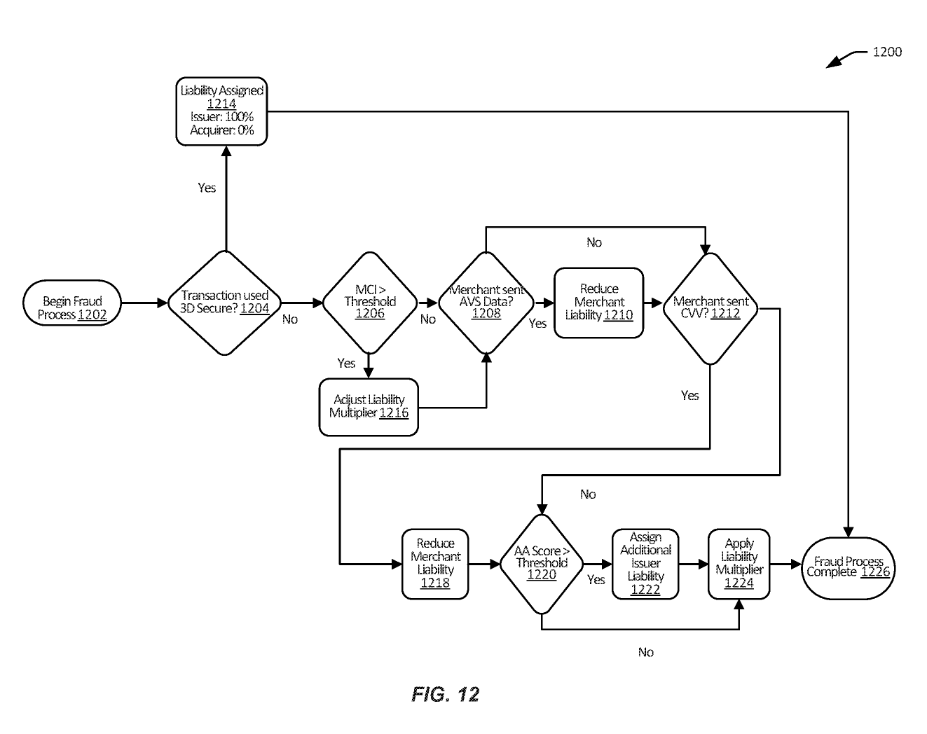

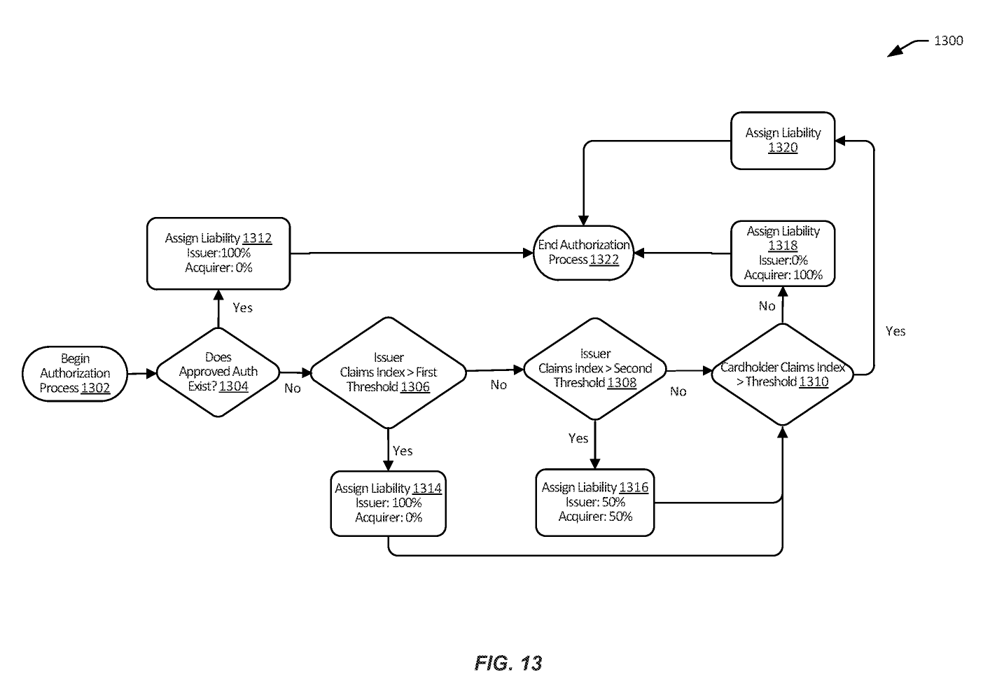

The resolution system 150 may use the automated resolution module 154 to assign transaction liability. The automated resolution module 154 may compare the transaction information, and/or the dispute histories/indices of each party, with a set of rules and regulations for determining which parties are liable. Various condition logic flows may be employed depending on the transaction information and/or the reasons for dispute provided by the issuer 130 or consumer 140. For example, different processes may be provided for assigning liability due to suspected authorization errors, processing errors, and/or fraud. Exemplary procedures for determining liability based on rules and regulations, as well as reasons for using those procedures, are shown in FIGS. 12-13.

If there is sufficient information for the automated resolution module 154 to assign liabilities, the dispute may be resolved after applying the condition logic. The automated resolution module 154 may accordingly divide up the allocation of the transaction value among the involved parties. For example, if the issuer 130 is found to be liable for 35% of the transaction, the issuer 130 may be allocated 65% of the transaction value.

If more information is needed to determine liability, the resolution system 150 may request that the issuer 130, consumer 140, acquirer 110, and/or merchant 105 provide additional information about the transaction. The resolution system 150 may receive additional information, use it to determine the liability of each involved party, and accordingly divide the transaction value among the involved parties.

The resolution system may inform the issuer 130, acquirer 110, consumer 140, and/or merchant 105 of the resolution and allocation results. If it was determined that the issuer 130 should be allocated some or all of the transaction value, the acquirer may then refund the issuer 130 the indicated amount.

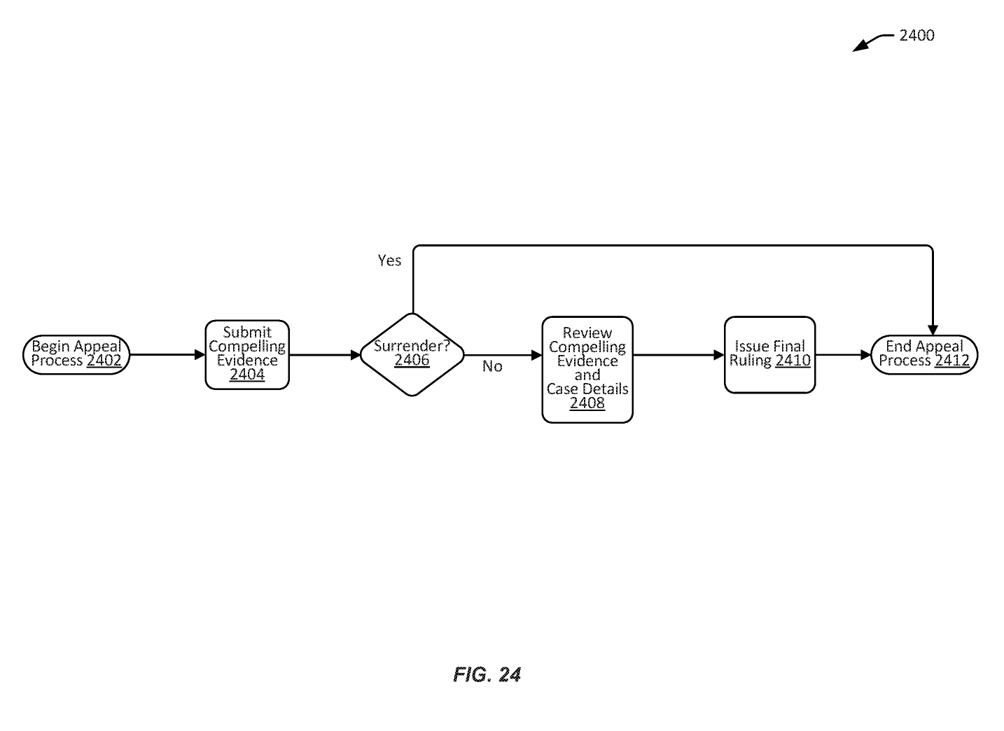

In some embodiments, involved parties, such as the issuer 130 or the acquirer 110, may be allowed to appeal the liability decision within a certain amount of time, such as 10 days. More information may be collected from one or more involved parties, and the transaction may be manually reviewed to determine a new liability distribution or reaffirm the original result. An exemplary appeal process is shown in FIG. 24.

### Overall Resolution Process

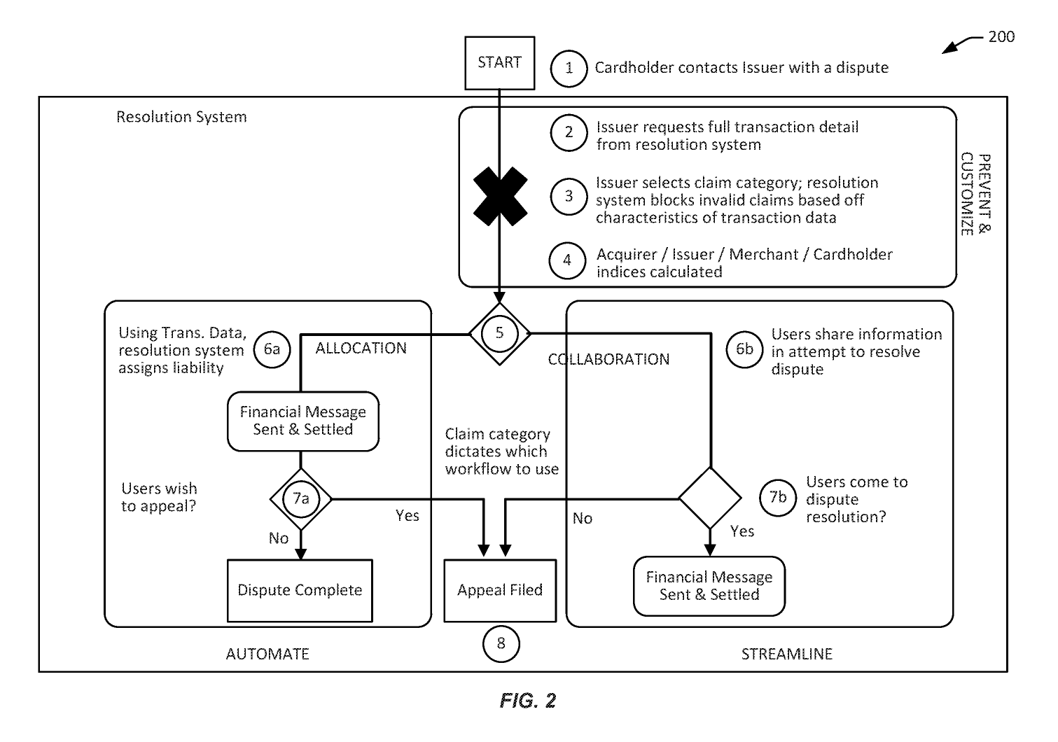

FIG. 2 shows an exemplary dispute claim resolution process 200, in accordance with embodiments. Aspects of the dispute claim resolution process 200 may be implemented by a resolution system such as the resolution system 150 discussed in FIG. 1. The steps illustrated in the resolution process 200 may be performed by one or more components of the resolution system to resolve a dispute claim regarding a disputed payment transaction. Some or all aspects of the process 200 (or any other processes described herein, or variations and/or combinations thereof) may be performed under the control of one or more computer/control systems configured with executable instructions and may be implemented as code (e.g., executable instructions, one or more computer programs or one or more applications) executing collectively on one or more processors, by hardware or combinations thereof. The code may be stored on a computer-readable storage medium, for example, in the form of a computer program comprising a plurality of instructions executable by one or more processors. The computer-readable storage medium may be non-transitory. The order in which the operations are described is not intended to be construed as a limitation, and any number of the described operations may be combined in any order and/or in parallel to implement the processes.

The resolution system may be configured to receive a claim request regarding a disputed transaction. The claim request may be generated by any user of the resolution system (e.g., an issuer, an account holder or a cardholder, a merchant, an acquirer). For instance, an issuer may submit a claim request in response to a cardholder contact with the issuer regarding a disputed payment transaction (e.g., at step 1 of FIG. 2). Alternatively, the claim request may be generated in response to an issuer-initiated or a third-party-initiated communication. The initial contact or communication may be via email, text, phone call, or in-person communication. While the following discussion assumes that a claim request is initiated by an issuer, it is understood that the issuer can be replaced by other entities such as an account holder, a cardholder, a merchant, an acquirer, a payment processor, and the like.

The issuer may optionally initiate a transaction inquiry with the resolution system to obtain full transaction details surrounding the disputed transaction (e.g., at step 2 of FIG. 2). The transaction inquiry may be used by an issuer to resolve a dispute claim and/or prepare for claim filing with the resolution system. In some cases, the transaction inquiry may be initiated by the issuer when a cardholder is online. In other cases, the transaction inquiry may be initiated by the issuer when a cardholder is offline. FIG. 4 shows an exemplary transaction inquiry process.

The issuer may submit the claim request via an online resolution interface such as the online resolution interface 152 discussed in FIG. 1. The online resolution interface 152 may be configured to allow parties of a dispute claim (e.g., issuer, acquirer, merchant, and/or cardholder) to participate in the claim resolution process. For instance, the online resolution interface 152 may be configured to allow an issuer to submit a claim request regarding a disputed claim (e.g., on behalf of a cardholder) and/or submit an appeal in response to a resolution decision. The online resolution interface 152 may be configured to allow parties to provide and/or update information that would aid the resolution process such as evidence regarding a disputed transaction from an issuer, acquirer, merchant, and/or cardholder. The online resolution interface 152 may be configured to allow parties to view information regarding the resolution process such as progress status, evidence provided by other parties, resolution decision, and the like. The online resolution interface 152 may also be used for an automated liability allocation process and/or a collaborative resolution process. In various embodiments, the online resolution interface 152 may be implemented using a graphical user interface (GUI), a web service, a programming application interface (API), or any other suitable mechanism.

A claim request may include information for identifying a disputed transaction. For example, the claim request may include a cardholder name or account identifier associated with the transaction, a type and/or an identifier of the payment device (e.g., credit card, electronic wallet), a time and/or location of the transaction, and the like. The claim request may also include information for determining what is being disputed about the transaction. For instance, the claim request may include an indicator that indicates a claim category such as discussed below. Depending on the claim category, the claim request may include information specific to the claim category. For example, different category-specific information may be provided for a claim request of processing errors than for a claim request of authorization irregularities. In some embodiments, claim categories can include “fraud” for a claim with fraud related issues, “processing” for a claim with processing related issues, “authorization” for a claim with authorization related issues, “inquiry” for an inquiry against the resolution system, “consumer” for a claim initiated on behalf of a consumer, “unrecognized” for an unrecognized claim, and the like.

The user of the resolution system (e.g., issuer, cardholder, merchant, acquirer) may use the online resolution interface 152 to submit a claim request and/or to create a dispute claim. For example, the claim request may be received in a web service request. As another example, the claim request may be created and submitted via an online form or questionnaire provided by the online resolution interface of the resolution system. The claim request can be used by the resolution system to generate a dispute claim. The dispute claim can be in the form of a data object with a plurality of attributes or fields generated based on the attributes of the claim request. For instance, a dispute claim can have data fields reflecting various characteristics of a disputed transaction (e.g., date, time, credit card number, cardholder name), claim category indicator, category specific data, and the like.

The online resolution interface 152 may provide an input form with a plurality of input fields that allow a user completing the form to enter information. In particular, the form may include a claim category field that allows a user to select a claim category for the dispute claim (e.g., at step 3 of FIG. 2). The claim category may be selected from a predefined group of categories such as fraud, authorization, processing error, consumer dispute, and unrecognized. Each of the claim categories may correspond to one or more specific scenarios (e.g., reason codes) that fall under that general claim category. For instance, the fraud claim category may be used to denote claims where fraud was or may have been involved include counterfeit transaction, fraudulent multiple transactions, fraud in a card-present environment, fraud in a card-absent environment, or fraud according to a merchant fraud performance program. The authorization claim category may be used to denote claims where authorization errors or irregularities were or may have been involved such as when a card recovery bulletin or exception file has been generated, when an authorization has been declined, when there was no authorization, when an expired payment card was used, when a service code is violated, and the like. The processing error claim category may be used to denote claims where processing errors or irregularities were or may have been involved such as late presentment, incorrect currency, transaction code violation, domestic transaction processing violation, non-matching account number, incorrect transaction amount or account number, duplicate processing, when the payment by other means (e.g., cash), and the like. The consumer dispute claim category may be used to denote claims where a factual dispute is raised by a consumer such as whether recurring transactions have been canceled, when a consumer alleges that a not-as-described or defective merchandise has been received by a consumer, when credit was not processed, when services were not received or when merchandise was not received, when a receipt was not received for a cash or load transaction at an ATM, and the like. The unrecognized claim category may be used to denote claims that do not fall into any of the above-discussed claim categories. Besides providing a specific claim category, the user may also provide other information using the online resolution interface such as a transaction identifier, cardholder account identifier, time, and/or location of the disputed transaction, transaction type, transaction amount, and the like.

In some embodiments, the claim category and/or other attributes of a dispute claim may be selected manually by a user (e.g., issuer or account holder) via the user interface. In some other embodiments, the claim category and/or other attributes of a dispute claim may be provided automatically by the resolution system. For example, the claim category may be selected based on transaction data available to the resolution system that is relevant to the disputed claim. In yet other embodiments, the claim category and/or other attributes of a dispute claim may be provided in a semi-automated fashion. For instance, a default value for the attribute may be provided by the resolution system and the default value may be editable by a user via the user interface.

The resolution system may be configured to validate a dispute claim submitted by a user of the resolution system (e.g., an issuer) based at least in part on the transaction information regarding the disputed transaction (e.g., at step 3 of FIG. 2) such as discussed herein. In some cases, validation may be based on additional information such as data entered in a claim form or questionnaire. The claim validation may be performed immediately after a user submits a claim and before the claim is further processed by the resolution system. Only valid claims may be subject to further processing. Invalid claims may be rejected without further processing. Since the transaction information used for claim validation is typically readily available to the resolution system, such validation can typically be performed relatively quickly and inexpensively. By validating incoming claims in a preliminary manner, the present invention allows the resolution system to spend less system resources on processing invalid claims and more system resources on processing valid claims, thereby increasing the efficiency and scalability of the resolution system.

The validation of the dispute claims may be based on a predefined set of validation rules. The validation rules may be selected based on one or more attributes of the dispute claim being validated and/or one or more attributes not being validated. The selected rules may be applied based on the transaction data to ensure that some or all of the attributes associated with a claim are correct or accurate according to the rules. For instance, a set of validation rules for validating the claim category of a dispute claim may be predefined. During the validation process, a subset of the claim category related validation rules may be selected based on the user-selected claim category for the dispute claim. The selected, attribute-specific subset of validation rules may be applied to the dispute claim attribute based at least in part on transaction data associated with transaction and/or claim to determine whether the attribute and/or claim is valid.

As an example, if a user selects “authorization” as the claim category, then a validation rule that is used to validate the claim may specify that the transaction must involve authorization. During the validation process, this validation rule may be selected based on the user-selected claim category and applied based on the actual transaction data associated with the transaction and/or claim. If it is determined that, based on the transaction data, there was no authorization involved in the transaction, then the selected claim category and/or the dispute claim can be determined to be invalid. Otherwise, the selected claim category and/or the dispute claim can be determined to be valid.

A dispute claim that is determined to be valid may be allowed to be further processed by the resolution system. A dispute claim that is determined to be invalid may be rejected and therefore removed from further processing by the resolution system. The result of the claim validation may be optionally provided, for example, in a warning/error message to the requestor of the dispute claim or a log file. In some cases, the claim validation may be performed after the user submits the claim. Alternatively or additionally, the claim validation may be provided dynamically while the user fills out the claim. In some embodiments, a user may be given the opportunity to correct and re-submit a previously invalid claim. In other embodiments, a user may be required to submit a brand new claim. In various embodiments, the claim validation may be performed by a front-end process (e.g., browser script), back-end process (e.g., server script), or a combination of both. In some cases, validation may be optional and/or omitted when the attributes that are auto-populated by the system. For example, if the claim category is automatically provided by the system, validation of the claim category may be omitted.

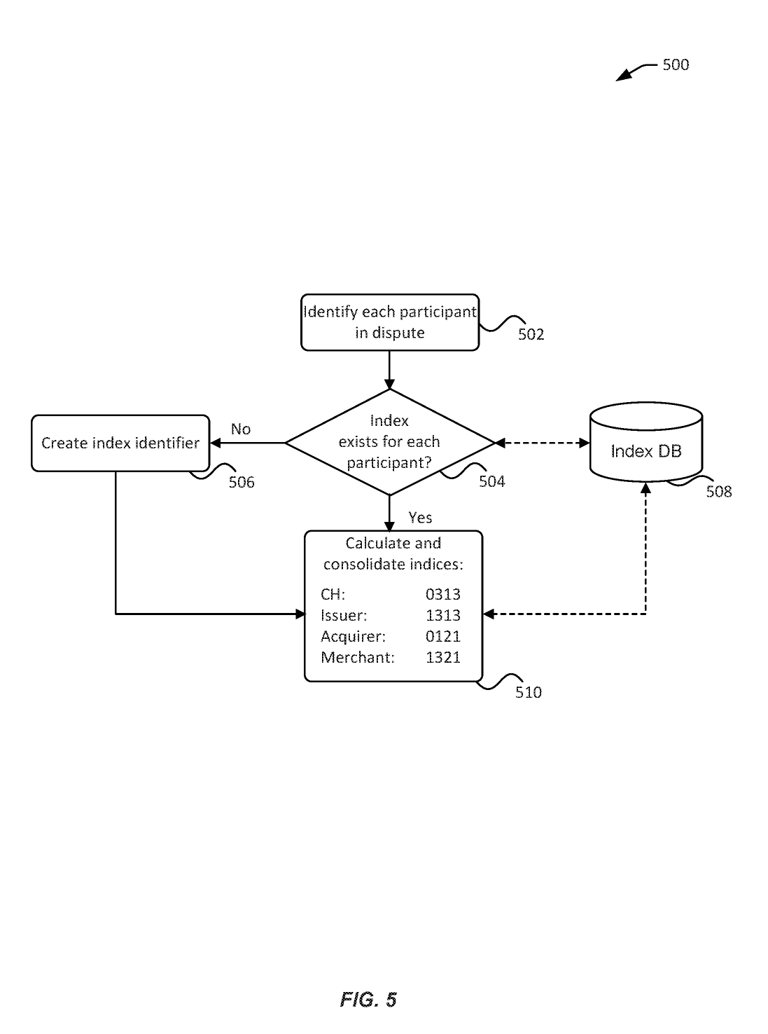

The resolution system may be optionally configured to calculate one or more dispute performance indicators for some or all of participants of a disputed transaction (e.g., at step 4 of FIG. 2). The participants of the disputed transaction may be identified based on the claim request. For instance, the participants can include the requestor of the claim request, and a cardholder and/or merchant identified in the claim request. Each participant may be associated with one or more dispute performance indicators. The dispute performance indicator of a participant may indicate that participant's performance in historical disputes over a time period (e.g., past 24 months). The indicator may indicate a behavioral pattern associated with the participant. The indicator may be used to track and/or monitor activities including misuse by participants in a dispute processing ecosystem. The dispute performance indicators may be used to measure positive aspects of the participants such as success rate in past disputes. Alternatively or additionally, the dispute performance indicators may be used to measure negative aspects of the participants such as failure rate in past disputes. In some cases, the dispute performance indicator may be represented by a numerical expression such as an index or a score. For example, the index may be measured as the original volume versus chargeback/claim rate. Other representation may also be used such as alphanumeric strings, binary numbers, or the like. FIGS. 5-9 illustrate exemplary processes for determining such dispute performance indicators for participants of a disputed transaction.

Still referring to FIG. 2, a workflow process used to process the dispute claim may be selected based at least in part on a claim category associated with the dispute claim (e.g., at step 5 of FIG. 2). The selection may be automatically, semi-automatically, or manually. For example, an automated liability allocation process (e.g., allocation process at steps 6a and 7a of FIG. 2) may be used to resolve a dispute claim where the resolution of the claim does not require information from sources other than the resolution system. For instance, if a claim has a claim category of “authorization” or “fraud,” it may be processed according to the allocation process. Under such a process, an allocation liability may be determined by the resolution system based solely or primarily on information already in possession by the resolution system.

Once it is determined that a dispute claim is to be processed under an automated allocation process, a category-specific workflow may be further selected based on the claim category, the specific characteristics of the dispute claim, and/or a set of predetermined allocation rules. For example, FIG. 12 shows an exemplary process for processing claims falling under a “fraud” claim category, in accordance with embodiments. FIG. 13 shows an exemplary process for processing claims falling within an “authorization” claim category, in accordance with embodiments.

On the other hand, a collaborative process involving input from one or more parties (e.g., a collaboration workflow at steps 6b and 7b of FIG. 2) may be used to resolve a dispute claim where the resolution of the claim requires information or evidence from sources other than the resolution system (e.g., issuer and/or acquirer). The collaboration process may allow stakeholders of a disputed transaction such as issuers, acquirers, merchants, and/or even cardholders to share relevant information in order to reach a dispute resolution. For instance, if a claim with a claim category of “processing error” or “consumer dispute” may be processed according to the collaboration process. The allocation process may be governed at least in part on a set of predetermined collaboration rules. The collaboration rules may be used to automatically allocate liabilities among parties (e.g., based on a response timeline) so as to shorten the time required to resolve a dispute. FIGS. 14-21 illustrate exemplary collaboration processes implemented by a resolution system, in accordance with embodiments.

In some embodiments, if a dispute claim is not resolved by a collaborative process, the dispute claim may be subject to an additional automated allocation process. In some other embodiments, if a dispute claim is not resolved by an automated allocation process (e.g., due to insufficient evidence), the dispute claim may be subject to an additional collaborative process.

In some embodiments, a claim with an “unrecognized” claim category may be processed manually (e.g., by a system administrator) or by a process or workflow that is different from the allocation process and the collaborative process above. In some embodiments, a system administrator or an automated process may select a non-“unrecognized” claim category for a claim with an “unrecognized” claim category based on transaction data of the claim and/or additional participant-provided information before sending the claim to the allocation process or collaboration process for further processing.

The resolution system can resolve disputes quickly and inexpensively. Using the automated allocation process, allocation of liabilities for a dispute claim may be achieved in a matter of seconds or milliseconds and the results can be made available to the parties almost instantaneously (e.g., via a user interface, email, text, or telephone call). Using the collaboration process, a dispute claim may be resolved in a streamlined fashion within a short amount of time, such as, for example, within a day, 48 hours, 5 days, 10 days, 15 days, 30 days, 45 days, and the like from the time a consumer 140 reports a dispute. The resolution system may be able to resolve all disputes within a maximum amount of time, such as, for example, within 10 days, 20 days, or 45 days.

In general, a majority of the incoming claims (e.g., 66%) can be processed using the allocation workflow/process and a minority of the incoming claims (e.g., 20%) are processed using the collaboration workflow/process. A minority of the incoming claims (e.g., 14%) may be rejected as invalid claims (e.g., at step 3). As such, the resolution system can be configured to process more incoming claims and resolve claims more quickly compared with traditional dispute resolution systems at least in part due to the automated liability allocation and claim validation.

In an embodiment, liabilities among parties may be shifted and/or adjusted at different stages of the resolution process without the shifting of funds corresponding to the liability allocation. In some embodiments, the fund shifting only occurs after the resolution of the dispute (e.g., at steps 7a and 7b of FIG. 2), at which point financial messages may be generated and sent to the relevant parties.

An involved party, such as the issuer or acquirer, may decide to appeal after transaction liability has been assigned according to an allocation process or if a dispute is not resolved under a collaboration process. An exemplary appeal process is shown in FIG. 24.

FIG. 3 shows another exemplary dispute claim resolution process 300, in accordance with embodiments. Aspects of the dispute claim resolution process 300 may be implemented by a resolution system such as the resolution system 150 discussed in FIG. 1. The process 300 is similar to the process 200 illustrated in FIG. 2 in certain aspects but different in other aspects.

At block 302, an issuer initiates a dispute claim with respect to a transaction. The issuer may proceed by filing a dispute claim with a payment processing network which can use a resolution system to resolve the dispute, or the issuer may file the dispute claim directly with the resolution system. The issuer may file a claim request via an online resolution interface such as discussed in FIGS. 1-2. A dispute claim may be generated based on the filed claim request. The dispute claim may include a transaction ID, payment account information, one or more reasons for the dispute, transaction conditions, and any other suitable information. In some embodiments, the dispute claim can include an indicator of a claim category indicating a category for the dispute claim. The indicator may be assigned or provided by the issuer, e.g., via the online resolution interface. Alternatively, the indicator may be assigned automatically by the resolution system based on information provided by the issuer. In various embodiments, any suitable entities may file dispute claims, including merchants, acquirers, consumers, and the like.

When the resolution system receives a transaction dispute claim, the resolution system may notify any other parties that are associated with the transaction, such as an acquirer, a merchant, and/or a consumer, that the dispute claim was filed. The notification may be provided via any suitable communication channels such as email messages, text messages, phone calls, and the like.

At block 304, the resolution system may optionally execute a transaction inquiry to acquire more information about the disputed transaction. The transaction inquiry may be initiated using any suitable information obtained from the claim request and/or the dispute claim. For instance, the transaction inquiry may be initiated using a Personal Account Number (PAN), a transaction identifier associated with the transaction, or any other suitable transaction identifying information. Using such transaction identifying information, a transaction record may be located and provided to the issuer and/or consumer. The transaction record may include detailed information about the transaction (e.g., date, time, amount, authorization details), detailed information about the parties that were involved in the transaction, and any other suitable information. An exemplary transaction inquiry process is shown in FIG. 4.

At block 306, it is optionally determined whether the dispute is resolved. The dispute claim may be resolved as the detailed transaction information becomes available. The dispute claim may be determined to be resolved when one or more parties involved in the dispute claim indicate a resolution to the dispute claim. For instance, upon receiving the detailed transaction information, a consumer may recognize and affirm a transaction that the consumer previously did not recognize and therefore disputed, thereby resolving the dispute claim. In another example, an issuer may recognize processing error based on the transaction details and therefore assumes responsibility for the dispute claim. In yet another example, a consumer and an issuer may agree on an allocation of liabilities between the consumer and the issuer based on the transaction details. The parties may indicate their desire to resolve the dispute claim based on the transaction information via the online resolution interface or using any other suitable communication methods (e.g., email, text, phone call).

In some other embodiments, the dispute may be automatically resolved by the resolution system based on detailed transaction information obtained at block 304. The resolution may be based on a set of predetermined rules and the transaction information. For instance, if the transaction amount associated with a certain PAN is higher than a certain threshold amount, the transaction may be determined to be potentially fraudulent. As another example, if a transaction velocity (e.g., number of transactions within a certain period of time) is higher than a certain threshold value, then the transaction may be determined to be invalid.

If the dispute claim is determined to be resolved at block 306, then the dispute resolution process 300 may end at block 334. Otherwise, if the dispute claim is not resolved at block 306, it is determined, at block 308, whether collaboration is needed to resolve the dispute, or whether one or more involved parties would like to collaboratively resolve the dispute. Collaboration may be necessary based on the claim category associated with the claim dispute. For instance, in an example, a claim dispute with a claim category of “processing error” or “consumer dispute” may be automatically subject to the collaboration procedure at block 310. Collaboration may be desirable based on a preference or indication of a user of the resolution system and/or a party involved in the dispute claim (e.g., an issuer, an acquirer, a consumer, a merchant). For instance, a party may indicate via the online resolution interface a preference to use a collaborative process to resolve the dispute.

If it is determined at block 308 that a collaboration process is to be used for resolving the dispute. Then a collaboration procedure may be executed, at block 310. Involved parties such as an issuer, an acquirer, a merchant, and/or a consumer may then collaboratively resolve the dispute by exchanging information using the resolution system. For instance, the parties may use the online resolution interface to provide or receive evidence or other information regarding the dispute, and to track status of resolution process. Exemplary collaboration procedures are shown in FIGS. 14-21.

If it is determined at block 312, that the collaboration process did not resolve the dispute, or if it is determined at block 308 that a collaboration process is not to be used, then the resolution process may proceed to a process for automatically allocating liabilities among the involved parties. In an example, the automated liability allocation process may be implemented by the automated resolution module 154 discussed in FIG. 1. Depending on the dispute claim, a resolution process or workflow may be selected from a plurality of predetermined resolution processes or workflows. The selected resolution process may then be applied to the dispute claim to determine an allocation of liabilities among at least two parties associated with the dispute claim.

The selection of the applicable resolution process may be based on a claim category of the dispute claim. For example, as illustrated in FIG. 3, if the claim category of the dispute claim is “authorization,” indicating that the dispute claim is related to authorization issues (block 314), then an authorization procedure is executed at block 320. The authorization procedure can be configured to handle disputes related to common authorization processing errors. An exemplary authorization procedure is shown in FIG. 13. If the claim category of the dispute claim is “processing” indicating that the dispute claim is related to processing issues (block 316), then a processing procedure is executed at block 322. The processing procedure may be configured to handle disputes related to common processing errors such as duplicative processing, incorrect transaction amount, and the like. If the claim category of the dispute claim is “fraud” indicating that the dispute claim is related to potential fraud issues (block 318), then a fraud procedure is executed at block 324. The fraud procedure can be configured to assign liability using statistical metrics that reward good behavior and punish bad behaviors. An exemplary authorization procedure is shown in FIG. 12.

The selection of the applicable resolution process may also be based on transaction information. For instance, a set of predetermined rules may be applied automatically to certain characteristics of the transaction to determine which resolution process should be selected for processing the claim dispute. Any suitable transaction attribute or combination of attributes may be used for selecting the suitable resolution process. For instance, transactions that occurred in certain geographic regions and/or at certain time may be subject to certain predetermined resolution processes specific to those geographic regions and/or time. Transactions with PANs within a certain PAN range may be subject to resolution processes specific to the particular PAN range. Transactions related to a particular issuer, acquirer, merchant, or consumer, or a group thereof, may be subject to entity specific resolution processes.

At block 326, liability of at least one or more parties involved in the dispute claim is assigned as a result of the automated allocation process 320, 322, or 324. In some embodiments, assignment of the liabilities may be based at least in part on dispute performance indicators respectively associated with the involved parties. The dispute performance indicators may be calculated based at least in part on the dispute histories respectively associated with the parties. FIGS. 5-9 illustrate exemplary processes for determining such dispute performance indicators for participants of a disputed transaction.

If there is sufficient information to assign liabilities, the dispute may be resolved after applying the suitable resolution procedure. The transaction value may then be divided among the involved parties according to the assigned liabilities. For example, if an issuer is found to be liable for 35% of the transaction, the issuer may be allocated 65% of the transaction value.

If more information is needed to determine liability, the resolution system may request that the participants of the dispute (e.g., an issuer, a consumer, an acquirer, and/or a merchant) provide additional information about the transaction. The resolution system may receive the additional information, use it to determine the liability of each involved party, and accordingly divide the transaction value among the involved parties.

The participants of the dispute claim may receive notification of the resolution result. The participants may act according to the resolution result. For example, if it was determined that the issuer should be allocated some or all of the transaction value, the acquirer may then refund the issuer the indicated amount.

At block 328, the involved parties, such as the issuer or the acquirer, may be allowed to file an appeal of the liability decision generated at block 326 within a certain amount of time from the receipt or the generation of the result, such as 10 days. If an appeal is determined to have filed, at block 330, then an appeal process may be executed. More information may be collected from one or more involved parties, and the transaction may be manually reviewed to determine a new liability distribution or reaffirm the original result. An exemplary appeal process is shown in FIG. 24.

### Transaction Inquiry

FIG. 4 shows an exemplary transaction inquiry process 400, in accordance with embodiments. The transaction inquiry process 400 may be used by a user of the resolution system (e.g., an issuer) to resolve a dispute claim and/or prepare for claim filing with the resolution system. Aspects of the dispute claim resolution process 400 may be implemented by a resolution system such as the resolution system 150 discussed in FIG. 1. In some embodiments, the transaction inquiry process 400 may be used to implement step 2 of the process 200 of FIG. 2 and/or block 304 of the process 300 of FIG. 3.

At block 402, a transaction inquiry process 400 is initiated. The transaction inquiry process can be initiated using a PAN or a transaction ID associated with a transaction, or any other suitable information that identifies a transaction. The information used to initiate the transaction inquiry process can be obtained from the claim request and/or dispute claim. In some embodiments, the transaction inquiry process may be initiated by a user, for example, via the online resolution interface discussed above. Or, the transaction inquiry process may be initiated automatically as part of the resolution process discussed in FIGS. 2-3. For instance, if the claim dispute include information that indicates that the cardholder does not recognize the transaction (e.g., when a “transaction not recognized” flag is set), then the transaction inquiry process may be automatically initiated to obtain additional information to help the cardholder recognize the transaction.

At block 404, the transaction details may be provided to one or more participants of the dispute claim (e.g., an issuer, an acquirer, a merchant, or a consumer). The transaction details may be retrieved from a transaction database or any other suitable data store that is accessible to the resolution system. For instance, the transaction details may be obtained from a clearing record about the transaction in a database operated by a payment processing network or an issuer based on the transaction identifying information discussed above (e.g., PAN or transaction ID). The transaction details may be displayed on the online resolution interface. For instance, a summary view of the transaction with transaction details may be provided to an issuer. In some cases, the transaction details may be provided to one or more participants via other communication channels such as emails, text messages, telephone calls, and the like.

At block 406, additional information about a merchant of the transaction may be optionally obtained from a third-party database and combined with the transaction information discussed in block 404. In an embodiment, the additional information may be obtained to help a card holder identify the transaction in dispute. For example, a dispute claim may be filed for an unrecognized transaction. The cardholder may not recognize the transaction and additional information beyond the data in the clearing record may be needed to assist the cardholder to identify the transaction. The third-party database may be a Global Merchant Repository (GMR) that includes information about merchants, franchises, corporations, and any other suitable business entities. The merchant of the transaction may be determined based on a merchant identifier or other merchant identifying information. The merchant identifying information may be determined based on information included in the original claim request and/or dispute claim, or the transaction information discussed in block 404. In some embodiments, the additional information may include information besides merchant information.

At block 410, it is optionally determined whether to provide the transaction information (including the additional merchant information) to a consumer (e.g., cardholder) of the dispute claim. The determination may be based on an indicator or flag of the resolution system. The indicator or flag may be set by a system administrator and/or a user of the resolution system, along with delivery options. Delivery options may include a delivery method (e.g., via email, text, or voice call), a delivery time frame, a delivery frequency, and the like.

If it is determined at block 410 that the transaction information is to be provided to the consumer, then at block 412, the transaction information is provided to the consumer according to the delivery options. Optionally, the transaction information may be provided as a “white-label” service. For instance, the transaction information may be provided to a consumer on behalf of a merchant or an issuer.

Once the transaction information is delivered, or if it is determined that the transaction information need not be provided to the consumer, the transaction inquiry process ends at block 414. In some embodiments, the transaction information obtained during the transaction inquiry process 400 may be stored temporarily or permanently in a database of the resolution system, so that the transaction information can be subsequently used by other steps of the resolution process discussed in FIGS. 2-3 for resolving the same or a different claim dispute.

In some embodiments, statistics about the transaction inquiry process may be provided to one or more participants of the dispute claims. For example, a report 416 may be provided to an acquirer that includes information about which merchants are frequently involved in transaction inquiries. Such information may help the acquirer perform risk/fraud analysis about the merchant, determine policies regarding the merchant, and the like. In an example, frequent involvement in the transaction inquiry processes may indicate a higher likelihood of risk or fraud for a merchant. In some embodiments, the frequency of involvement in transaction inquires may be taken into account when calculating a performance indicator of the merchant.

### Performance Indicator Calculation

As discussed above, an allocation of liabilities among participants in a dispute claim may be determined based at least in part on performance indicators (also referred to as indices) respectively associated with the participants. FIGS. 5-9 below show exemplary processes for determining dispute performance indicators, in accordance with embodiments. Aspects of the indicator calculation processes 500-900 may be implemented by a resolution system such as the resolution system 150 discussed in FIG. 1. In some embodiments, indicator calculation processes 500-900 may be used to implement step 4 of the process 200 of FIG. 2 and/or as before the allocation procedures 320, 322, or 324 of the resolution process 300 of FIG. 3.

FIG. 5 shows an exemplary overall process 500 for dispute performance indicators (also referred to as indices) of participants in a dispute, in accordance with embodiments.

At block 502, participants in a disputed claim are identified. The participants can include a cardholder, a merchant, an acquirer, an issuer, and any other suitable entity that participated in the transaction. The participants can be identified based on transaction information obtained from the original claim request and/or additional transaction information obtained as part of the transaction inquiry process discussed in FIG. 4. For instance, a cardholder and/or an issuer may be identified from a PAN used in the transaction and a merchant may be identified by a merchant identifier in the transaction information.

At block 504, it is determined whether an index identifier exists for each of the participants. To this end, an index database 508 may be queried using information of the participant.

If a participant does not have an existing index identifier, it means that the participant has not been involved in a dispute handled by the resolution system. At bock 506, an index identifier is created in the index database 508 for the participant. The index may or may not be assigned a default index value.

If a participant does have an index identifier, then at block 510, an index value for the index identifier can be retrieved and/or updated. In some embodiments, a participant may have multiple indices. For example, each index may be associated with a different time period or type of activities. Some or all of these indices may be updated or re-calculated based on updated dispute or transaction history information. The indices may also be calculated based on transaction information obtained from the original claim request and/or subsequent transaction inquiry (e.g., FIG. 4). Additionally, the indices may be calculated based on the claim category that is associated with the dispute claim. Thus, the formula and/or data for calculating an index can vary based on a variety of factors such as transaction information, dispute claim category, dispute history information, and the like.

The calculation of the indices may be performed in real time or nearly real time right before the indices are needed. Alternatively, the indices may be pre-calculated by a background process. In some embodiments, the various indices associated with a participant may be consolidated to generate a consolidated index for the participant. For instance, the consolidated index may represent an average or an aggregate value of the various indices of the participant.

In some embodiments, the lookup (blocks 504 and 506) and calculation (block 510) of the indices are performed for each of the participants in a dispute claim. In some other embodiments, indices may be calculated for only some but not all of the participants. For instance, depending on the claim category of a dispute, the liability may be allocated only among a certain subset of the participants (e.g., between an issuer and an acquirer). In such cases, only the indices for the participants in the subset are obtained and/or calculated. The indices for the participants that are not in the subset are not obtained and/or calculated. Such an “as-needed” approach for obtaining and calculating indices can save the time and computational resources spent on index calculation, making the resolution process more efficient and streamlined.

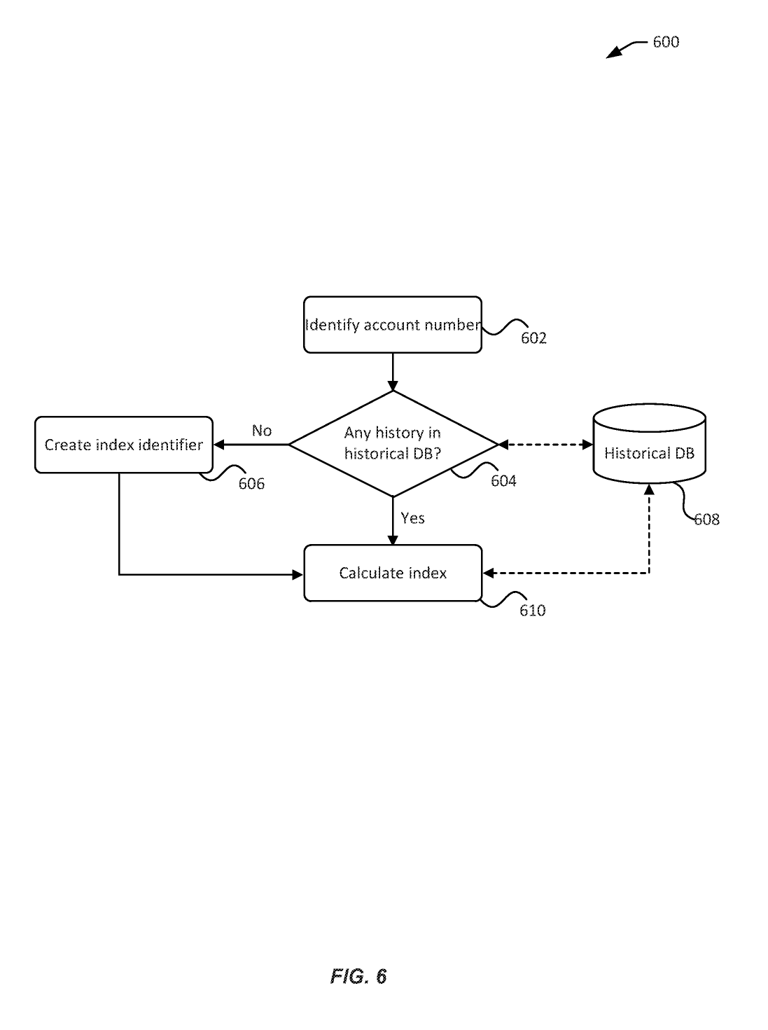

Calculation of the dispute performance indicator may or may not vary depending on the type of entity for which the indicator is calculated. FIG. 6 shows an exemplary process 600 for determining a dispute performance indicator (index) associated with a cardholder, in accordance with embodiments. At block 602, an account number associated with the cardholder is identified. For instance, the account number may be derived from a PAN used in a transaction. At block 604, a historical database 608 is queried to determine whether there is any existing history data associated with the identified account number. The historical database 608 may be configured to store historical data related to transactions, disputes, or a combination of both. If it is determined that there is no history (e.g., dispute history data) associated with the account number, then at block 606 an index identifier is created for the account number. If it is determined that there is historical data associated with the account number or if a new index is created for the account number, then an index value may be calculated or updated based on the historical data. A default index value may be optionally assigned to a newly-created index. The updated index value may be stored in the historical database.

The calculation of the dispute performance index for the cardholder may occur in any suitable manner. For example, a dispute performance index for a cardholder may be very high if the cardholder tends to dispute many, many transactions. On the other hand, the dispute performance index for a cardholder may be low if the cardholder has a long history of trustworthy activity and few disputes. In this specific example, a low performance index may be more likely to result in a favorable outcome for the card holder than a high performance index (or vice-versa). Various other factors can be used to calculate a performance index for a cardholder. Such factors might also include the cardholder's transaction history, etc.

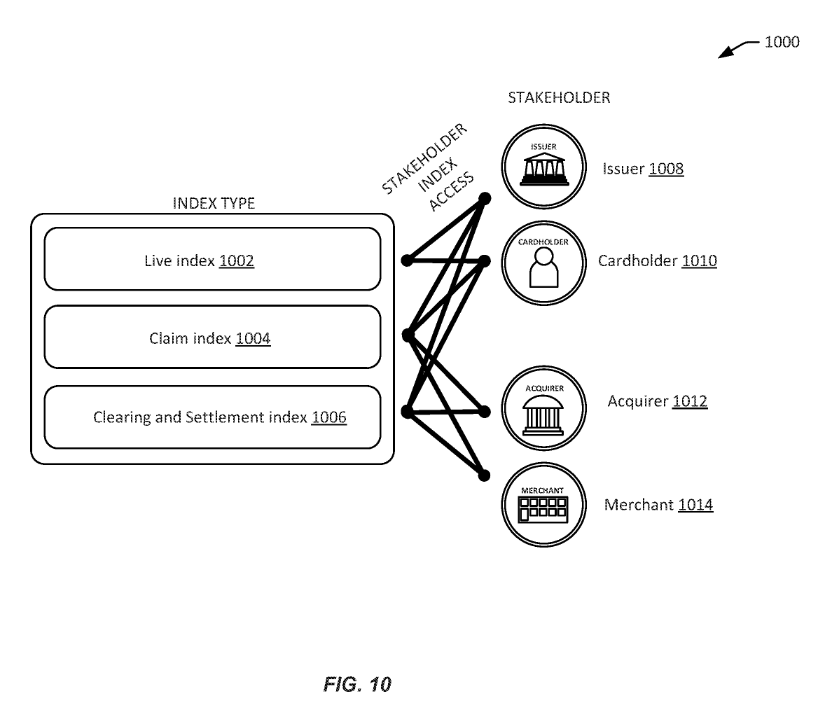

The resolution system may be configured to track dispute performance associated with participants of the dispute resolution system. The dispute performance may be tracked for a predetermined or arbitrary length of time (e.g., 12 months or 24 months). Different types of dispute performance indicators (indices) may be calculated and/or updated at different stages of a resolution process. For example, FIG. 10 shows three types of indices that may be associated with various participants, in accordance with embodiments. A live index 1002 can be calculated based on the data related to a participant that is derived from the current dispute claim and/or transaction information. In some embodiments, the live index can be calculated before a dispute claim is submitted to the resolution system. In other embodiments, the live index may be calculated after the claim is submitted. A claim index 1004 can be calculated based on historical data related to previous claims involve the participant, if any. In some embodiments, the claim index can be calculated after a dispute claim is submitted but before the claim is resolved. In other embodiments, the claim index may be calculated before the dispute claim is submitted or after the claim is resolved. A clearing and settlement (C&S) index 1006 can be calculated based on previous dispute resolution data such as clearing and settlement data related to the participant. In typical embodiments, the C&S index can be calculated after the claim is resolved and the financial liabilities are assigned, settled, and/or cleared among parties.

In various embodiments, different types of participants may be associated with different types of indices and hence different index calculation. FIG. 10 shows the stakeholders in a dispute claim, an issuer 1008, a cardholder 1010, an acquirer 1012, and a merchant 1014, and their respective types of indices accessible to the stakeholders. For instance, as illustrated in FIG. 10, an issuer or a cardholder can each be associated with all three types of indices. For an acquirer or a merchant, only the claim index and the C&S index are calculated and/or updated.

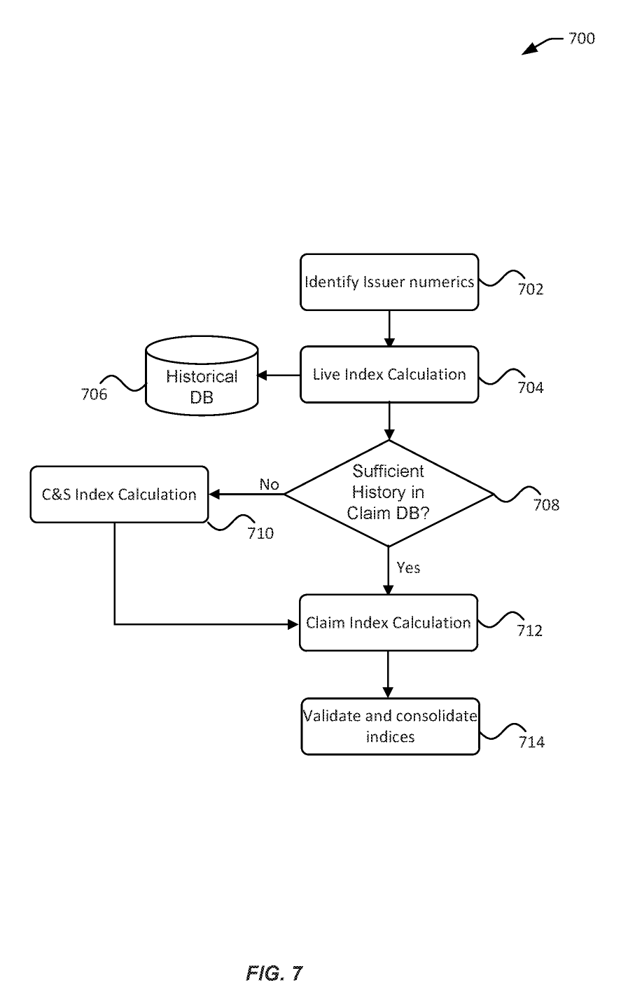

FIG. 7 shows an exemplary process 700 for determining a dispute performance indicator (index) associated with an issuer, in accordance with embodiments. At block 702, issuer numerics associated with an issuer are identified. The issuer numeric can include information about the issuer in an issuer profile that is enrolled with the resolution system. The issuer numerics are used to determine to calculate live index associated with the issuer. The calculated live index can be stored in a historical database 706 that may or may not be part of the resolution system. At block 708, a claim database (not shown) is queried to determine whether there is sufficient historical claim-related data that involves the issuer in the claim database to calculate a claim index. If there is insufficient claim-related data in the claim database, then at block 710, the C&S index for the issuer is calculated. Otherwise, if there is sufficient data in the claim database, or after the calculation of the C&S index, then at block 712 the claim index for the issuer can be calculated based on the historical claim-related data. At block 714, the live index, claim index, and C&S index calculated above are validated and consolidated. The indices may be validated against one or more predetermined validation rules. For instance, the rules may impose certain constraints (e.g., maximum or minimum) on the index values. If the validation fails for any of the indices, then a warning or error message may be provided to the issuer or any other user of the resolution system. Otherwise, the validated indices can be averaged, aggregated, or otherwise consolidated to generate a consolidated index for the issuer. The consolidated index value may be compared to index values associated with other participants in the dispute and/or one or more predetermined threshold values to determine how to allocate liabilities among the participants.

The calculation of the live index, the claim index, the C&S index, and/or the issuer index may be determined in any suitable manner. For purposes of illustration, the issuer index may be determined based upon historical data with regard to the security of the payment cards or devices that issues, the length of time that the issuer has been processing payments, the length of time that it takes the issuer to resolve disputes, the issuer's historical success in transaction disputes, etc.

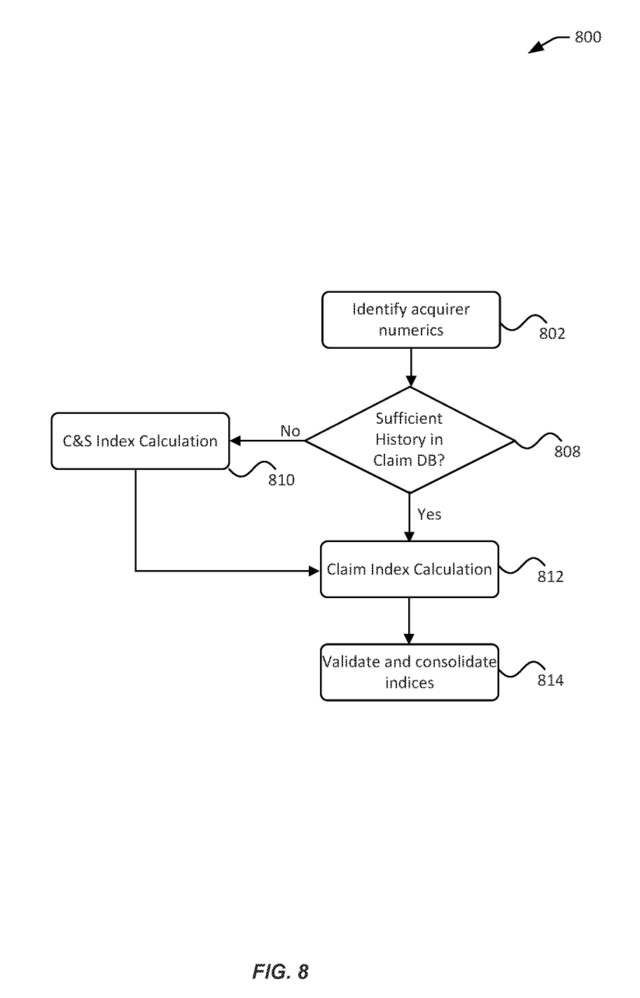

FIG. 8 shows an exemplary process 800 for determining a dispute performance indicator (index) associated with an acquirer, in accordance with embodiments. At block 802, acquirer numerics associated with an issuer are identified. Acquirer numerics can include information about the acquirer in an acquirer profile enrolled with the resolution system. At block 808, a claim database (not shown) is queried to determine whether there is sufficient historical claim-related data that involves the acquirer in the claim database to calculate a claim index. If there is insufficient claim-related data in the claim database, then at block 810, the C&S index for the acquirer is calculated. Otherwise, if there is sufficient data in the claim database, or after the calculation of the C&S index, then at block 812 the claim index for the acquirer can be calculated based on the historical claim-related data. At block 814, the claim index and C&S index calculated above are validated and consolidated. The indices may be validated against one or more predetermined validation rules. For instance, the rules may impose certain constraints (e.g., maximum or minimum) on the index values. If the validation fails for any of the indices, then a warning or error message may be provided to the acquirer or any other user of the resolution system. Otherwise, the validated indices can be averaged, aggregated, or otherwise consolidated to generate a consolidated index for the acquirer. The consolidated index value may be compared to index values associated with other participants in the dispute and/or one or more predetermined threshold values to determine how to allocate liabilities among the participants.

The acquirer index may be determined in any suitable manner. For example, the acquirer index can take into account the security of the merchant systems for its merchants, the length of time that the acquirer has been processing payments, the length of time that it takes the acquirer to resolve disputes, the acquirer's historical success in transaction disputes, etc.

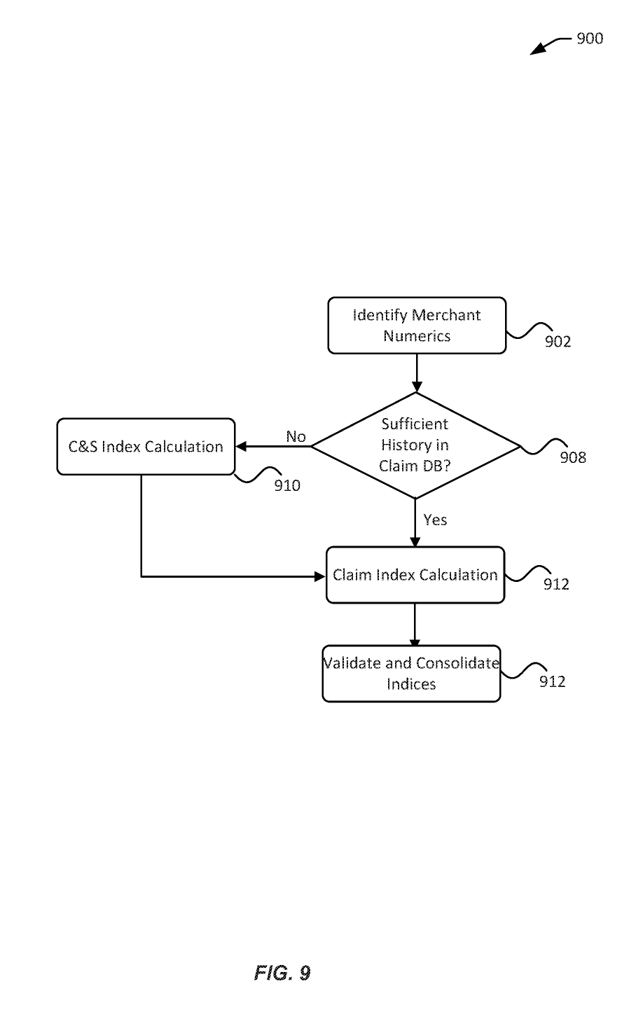

FIG. 9 shows an exemplary process 900 for determining a dispute performance indicator (index) associated with a merchant, in accordance with embodiments. At block 902, merchant numerics associated with a merchant are identified. At block 908, a claim database (not shown) is queried to determine whether there is sufficient historical claim-related data that involves the merchant in the claim database to calculate a claim index. If there is insufficient claim-related data in the claim database, then at block 910, the C&S index for the merchant is calculated. Otherwise, if there is sufficient data in the claim database, or after the calculation of the C&S index, then at block 912 the claim index for the merchant can be calculated based on the historical claim-related data. At block 914, the claim index and C&S index calculated above are validated and consolidated. The indices may be validated against one or more predetermined validation rules. For instance, the rules may impose certain constraints (e.g., maximum or minimum) on the index values. If the validation fails for any of the indices, then a warning or error message may be provided to the merchant or any other user of the resolution system. Otherwise, the validated indices can be averaged, aggregated, or otherwise consolidated to generate a consolidated index for the merchant. The consolidated index value may be compared to index values associated with other participants in the dispute and/or one or more predetermined threshold values to determine how to allocate liabilities among the participants.

The merchant index may be determined in any suitable manner. For example, the merchant index can take into account the security of the merchant systems, the length of time that the merchant has been processing payments, the length of time that it takes the merchant to resolve disputes, the merchant's historical success in transaction disputes, the number of disputes at the merchant and/or the frequency of disputes, the value of the disputes at the merchant, etc.

In some embodiments, the way that a dispute performance indicator is calculated may be entity-specific. For instance, a merchant's dispute performance indicator may be based on a chargeback/sales rate (i.e., a ratio between a historical chargeback amount and a historical sales amount). The historical chargeback amount and the historical sales amount may be a total amount, an average amount, a maximum amount, a minimum amount, or any suitable amount over a period of time. An acquirer's dispute performance indicator may be represented by a chargeback re-presentment rate. Alternatively, the dispute performance indicator may not be entity-specific. In other words, the dispute performance indicator may be entity-neutral in some embodiments. For instance, the dispute performance indicator may be measured by a percentage of past transactions where a dispute is raised, a rate of success or failure in historical disputes, or the like. A party may be deemed successful in a disputed transaction if it is found to not to be liable or if it is found to be less than 50% liable.

The party's dispute performance indicator may indicate the likelihood of potential liability in future transaction disputes. For instance, if a dispute performance indicator is represented by the percent of transactions where a party was found liable, the party with a relatively high indicator value may be more likely to be liable in the future than a party with a relatively low indicator value.

The value of a dispute performance indicator of a party may be compared with one or more predetermined threshold values to permit certain functions and/or to allocate liability of the party. The predetermined threshold values may be system-and/or user-defined. The predetermined threshold values may be based on a baseline value derived from dispute performance indicators of a group of entities. The group of entities may share similar characteristics with the party involved including type and/or size of business, geographical region, time period, and the like. In some cases, a party with a dispute performance indicator that falls above, below, or within pre-established threshold values is allowed by the resolution system to initiate or perform certain functions. For example, a party (e.g., a merchant) with a dispute performance indicator below or above a certain threshold may be allowed to supply additional evidence to the resolution system with respect to a disputed transaction. A party with a dispute performance indicator below or above a certain threshold may be allowed to raise an appeal based on a decision of liability made by the resolution system.

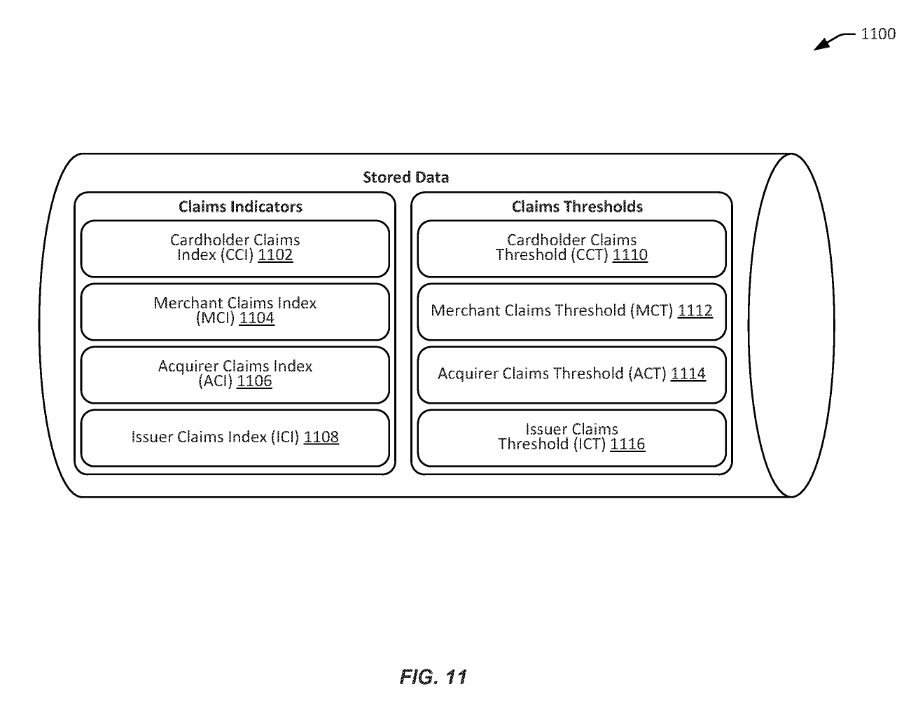

The value of a dispute performance indicator of a party may be compared with one or more predetermined threshold values to permit certain functions and/or to allocate liabilities of the parties. FIG. 11 shows exemplary data that can be used to allocate liability among participants of a disputed transaction, in accordance with embodiments. The data may be stored in one or more data stores that are accessible to a resolution process such as those discussed in FIGS. 2-3. Some or all such data can be updated before, during, or after a dispute resolution process based on transaction data, dispute data, or resolution result data. In some cases, some or all of such data may be updated on a periodic basis, for example, based on the filing, processing, and/or resolution of dispute claims.

As illustrated, the stored data can include claim indicators for various participants in dispute resolutions such as cardholder claims index (CCI) 1102, merchant claims index (MCI) 1104, acquirer claims index (ACI) 1106, issuer claims index (ICI) 1108, and the like. The CCI can be a number or any other representation of a specific cardholder's behavior for a given period of time (e.g., past 24 months). An MCI can be a number or any other suitable representation of a specific merchant's behavior for a given period of time (e.g., past 24 months). An ACI can be a number or any other suitable representation of a specific acquirer's behavior for a given period of time (e.g., past 24 months). An ICI can be a number or any other suitable representation of a specific issuer's behavior for a given period of time (e.g., past 24 months). The claims indicators may be calculated and/or updated based on claims history data involving the respective participants.

The stored data can also include thresholds corresponding to various claim indicators. The thresholds can be compared with the values of the claim indicators to determine the liability for the respective participants associated with the claim indicators. The claim thresholds can be defined by a system administrator, a user of the resolution system, or any other suitable entity. In some embodiments, the claim thresholds may be determined based on historical claim data using statistical analysis, data mining, machine learning, or other suitable techniques.

The claim thresholds can include a cardholder claim threshold (CCT) 1110, a merchant claims threshold (MCT) 1112, an acquirer claims threshold (ACT) 1114, an issuer claims threshold (ICT) 1116, and the like. The CCT can define a limit for acceptable cardholder claim behavior. In an embodiment, cardholders with CCI's above the CCT incur additional claim liability. In another embodiment, cardholders with CCI's below the CCT incur additional claim liability. The MCT can define a limit for acceptable merchant claim behavior. In an embodiment, merchants with MCI's above the MCT incur additional claim liability. In another embodiment, merchants with MCI's below the MCT incur additional claim liability. The ACT can define a limit for acceptable acquirer claim behavior. In an embodiment, acquirers with ACI's above the ACT incur additional claim liability. In another embodiment, acquirers with ACI's below the ACT incur additional claim liability. The ICT can define a limit for acceptable issuer claim behavior. In an embodiment, issuers with ICIs above the ICT incur additional claim liability. In another embodiment, issuers with ICIs below the ICT incur additional claim liability.

Other data can be generated, used, and/or stored as part of the dispute resolution process besides the claims indicators and the claim thresholds. For instance, a claim assurance indicator (CAI) can be generated for a participant of a dispute claim (e.g., an issuer, an acquirer, a merchant, or a cardholder). The CAI can indicate an estimated likelihood of claim success for the participant. For example, if a high CAI indicates a high chance of success, then a transaction that was conducted using a chip card, by a cardholder that has a history of few disputes and has been with the same issuer over time is may be deemed more likely to win a dispute with a merchant that has not been in business long, and has had many other disputes with other cardholders within a short period of time. The participants in a dispute claim may each have their own CAIs determined based on their dispute performance indicators and comparison with the dispute performance indicators of other participants. For example, an entity's CAI may be inversely related to its dispute performance indicator. A higher index may imply a lower CAI. For example, if an issuer may have an ICI that is higher than an ACI of an acquirer, then the issuer's CAI may be lower than the acquirer's CAI. In another example, a higher index may imply a higher CAI. Additionally or alternatively, the CAI may be generated based on previous transaction history and/or current transaction information.

In some embodiments, a CAI may be displayed to a participant using a user interface object on the online resolution interface. The value of the CAI may be indicated by the text, color, size, shape, or other characteristics of the user interface object. For instance, a green CAI indicator may be used to represent a relatively high likelihood of claim success for the participant. A yellow CAI indicator may be used to represent a relatively medium likelihood of claim success for the participant. A red CAI indicator may be used to represent a relatively low likelihood of claim success for the participant.

Additionally, a transaction fraud score may be calculated and assigned to every transaction. The transaction fraud score may predict the likelihood of a fraudulent transaction. The transaction fraud score may be calculated based on information included in the claim dispute, transaction information, and any other relevant data. In some embodiments, the transaction fraud score may also be determined on past transaction data, behavioral data (e.g., spending habits), and the like.

In some embodiments, the resolution system is configured to calculate dispute performance indicators only for those participants for whom a claim has been submitted and validated by the resolution system instead of for every single participant. For instance, if a participant is never involved in a disputed transaction, then his dispute performance indicator would never need to be calculated. Furthermore, once a participant's dispute performance indicator has been calculated, it may be stored and reused and/or updated in future dispute resolution. Advantageously, such a “just-in-time” approach allows the resolution system to optimize resources (e.g., CPU or memory) used for the calculation of dispute performance indicators while enjoying the benefits of the dispute performance indicators (e.g., during automated liability allocation process).

The dispute performance of entities may be tracked and monitored to detect outliers as compared with certain predetermined baseline values. Proactive interventions may be provided in response to the detection of such outliers. Such proactive intervention may include warnings, notifications to the party involved or to other stakeholders, increased scrutiny or monitoring for the party involved (e.g., fraud prevention or detection procedures), and the like. The proactive intervention may prevent dispute claims from being filed and/or mitigate the scope of the dispute claims.

### Allocation Processes

Depending on the claim category of the dispute claim, a different resolution process or workflow can be applied to the dispute claim to automatically allocate liabilities among the involved parties. The dispute resolution indicators, threshold values, and rules discussed above may be used by the resolution system to automatically allocate liabilities among relevant parties in a claim. Such automated liability allocation process is typically used to process a claim that requires little or no additional information from parties in the claim such as claims related to fraud or authorization errors. Most or all Information required to resolve such claims is typically readily available from a payment processing system which may include or be included in the resolution system.

Information used to allocate liabilities or otherwise process a dispute claim may include payment processing information, dispute information, and/or rules and regulations. The payment processing information may include transaction information, authorization information, and/or transaction participant information. A transaction participant may include a merchant, an acquirer, an issuer, a cardholder, or any other suitable entity participating in a transaction. Some of such payment processing information may be obtained by a payment processing system (which may or may not include the resolution system discussed herein) from requests and/or responses regarding payment and/or authorization that pass through the payment processing network and/or payment processing system. The payment processing information may also be provided by a transaction participant. The dispute information may include any information related to the processing of a dispute claim including dispute resolution status, liability allocation, performance dispute indicators, and the like. The dispute information may be provided by the resolution system. The rules and regulations may include a set of conditions or criteria and a set of actions. The satisfaction of the set of conditions or criteria may trigger the associated set of actions. The rules and regulations may be user-defined and/or system-defined. Some of such rules are illustrated in the flow diagrams shown herein.

Rules and regulations may be set that encourage the use of available tools to mitigate transaction risks. For example, in some embodiments, there may be a rule that gives liability protection to a merchant 105 that requires consumers to provide a security code during card-not-present transactions. The merchant 105 may be guaranteed that, if a card-not-present transaction is disputed where a security code was received, the merchant 105 will not be found liable for the entire charge, regardless of other circumstances. For example, the merchant may be given 10% liability protection, or any other suitable amount of protection.

In another example, an issuer 130 that authorizes transactions without using suggested fraud mitigation procedures may be responsible for a greater part of the loss associated with a fraudulent transaction during the dispute resolution process. For example, in some embodiments, a rule may be set that, if a transaction is disputed where the issuer 130 did not consider a risk score before authorizing, at least a portion of the transaction liability may be attributed to the issuer 130 if a transaction is found to be fraudulent. For example, the issuer 130 may be assessed with at least 10% liability for the disputed transaction, or any other suitable amount of liability.

The automated resolution module 154 may also consider the dispute histories of each involved party (e.g. the issuer 130, consumer 140, merchant 105, and acquirer 110), and the dispute histories may affect which parties are found liable for a disputed transaction. A dispute history may indicate a rate of disputes, a total amount of disputes, information about liability, the results of each dispute, and any other relevant information. A dispute history may also include a dispute score or a dispute index value, which may be based on disputes that occurred within recent history, such as the last two months. Records of disputes histories may be stored at the resolution system 150 or the payment processing network 120.

In some embodiments, a party with a higher rate of disputes may be considered more liable. For example, a relatively high amount of transactions that occurred at a certain merchant 105 may have been disputed. This may indicate frequent unsafe or untrustworthy behavior by the merchant 105. Accordingly, liability attributed to the merchant 105 may be higher. In another example, a consumer 140 that has reported a large amount of fraudulent transactions may be considered liable for future disputes, and/or future dispute claims from the consumer 140 may be rejected. Accordingly, consumers are discouraged from falsely reporting a fraudulent transaction or otherwise abusing the transaction dispute system. In some embodiments, dispute histories, and/or dispute index values, may be stored at the payment processing network 120 or at the resolution system 150. An exemplary process of determining liability based on dispute histories is shown in FIG. 12-13, and dispute histories are further described in FIG. 11. In some embodiments, the automated resolution module 154 may use both the dispute histories and the transaction information to determine which parties are liable for a disputed transaction.

In some embodiments, when liability is determined, one party may be held entirely liable or the liability may be divided. Accordingly, the automated resolution module 154 may determine that the transaction value should be allocated entirely to one party, or that allocation should be split between multiple parties. For example, 60% allocation may be awarded to the issuer 130, and 40% allocation may be awarded to the acquirer 110. In this case, the acquirer 110 may provide a refund of 60% of the transaction value back to the issuer 130. Thus, the resolution process may be fair and equitable, as the resolution system 150 may consider all relevant information, and allocation of funds may be divided according to liability.

In some embodiments, the transaction information and dispute histories may not be enough information for determining which parties are liable for the transaction, or more information may otherwise be desired. For example, if a dispute was filed because a consumer 140 was not satisfied with the quality of a purchased good or service, information beyond the transaction information and dispute histories may be useful for resolving the dispute. The resolution system 150 may request additional information from the consumer 140, issuer 130, acquirer 110, and/or merchant 105. The received information may then be used to resolve the dispute and assign liability.

FIG. 12 shows an exemplary process 1200 for processing claims related to fraud, in accordance with embodiments. During the process 1200, liabilities among participants of a transaction may be assigned and/or shifted based on various factors such as dispute performance indicators, transaction information, and the like. In some embodiments, the process 1200 may be performed based on a predetermined set of rules for handling claims having processing-related issues. In some embodiments, the process 1200 may retrieve, store, update, or otherwise use data described in FIG. 11. In general, a participant's utilization of a security feature or fraud prevention method tends to reduce that participant's liability.

At block 1202, the fraud process is started. The fraud process can be selected from a plurality of resolution processes or workflows based at least in part on a claim category indicator of a dispute claim. For instance, the claim category indicator may include an alphanumeric string such as “fraud,” a number, or any other suitable representation. The claim category indicator may be selected by a user or determined automatically by the resolution system. Additionally or alternatively, the fraud process can be selected based at least in part on transaction information.

The fraud process can be selected to process a claim with processing related issues. For instance, the fraud process can be selected to handle a claim arising from a “card not present (CNP)” situation where a cardholder may not have authorized or participated in the transaction, where the transaction was processed with a fictitious account number, or where no valid card was outstanding bearing the account number on the transaction receipt.

The fraud process can be selected to handle a claim arising from a “card present” situation, where the transaction may have been processed without the cardholder's permission and no card imprint was obtained, the cardholder's signature or PIN was missing on the receipt, or the account number is fictitious.

The fraud process can be selected to handle a claim arising from a “counterfeit transaction” situation, where a counterfeit card was used for a magnetic-stripe or chip-initiated transaction that received authorization but the authorization request did not include the required data, contained altered data, or a counterfeit transaction occurred at a merchant or member location where risk control procedures were not followed.

At block 1204, it is determined whether security procedures were performed in the transaction, for example, based on transaction information. For instance, it may be determined whether online authentication steps such described in 3-D Secure were performed. In the 3-D Secure protocol, an authentication is based on a three-domain model which includes acquirer domain (e.g., the merchant and the acquirer bank to which money is being paid), issuer domain (e.g., the issuer bank which issued the card being used), and interoperability domain (e.g., the infrastructure provided by the financial card to support the 3-D Secure protocol including the Internet, access control server (ACS) providers, merchant plug-in (MPI) providers, or other software providers).

If it is determined at block 1204 that 3-D Secure or another type of authentication mechanism was used in the transaction, then at block 1214, the issuer may be assigned 100% liability whereas the acquirer may be assigned 0% liability. In some other embodiments, the issuer may be assigned a liability that is less than 100% and the acquirer may be assigned a liability that is more than 0%. In general, the use of 3-D secure or other types of authentication mechanisms reduces the liability of a merchant or an acquirer and increases the liability of an issuer. Hence, the issuer may be assigned a liability greater than that assigned to an acquirer.

If it is determined at block 1204 that 3-D Secure or another type of authentication mechanism was not used in the transaction, then at block 1206, it is determined whether the merchant claims index (MCI) associated with the merchant exceeds a corresponding threshold such as the merchant claims threshold (MCT). Discussion of MCI and MCT is provided in FIG. 11 above. MCI can be a number or any other suitable representation of a specific merchant's behavior for a given period of time (e.g., past 24 months). The MCT can define a limit for acceptable merchant claim behavior.

If the MCI exceeds the MCT, then at block 1216, one or more liability multipliers for one or more parties may be adjusted. For instance, the liability multiplier for a merchant may be adjusted (e.g., from 0.5 to 0.7) so as to increase the liability of the merchant. As another example, the liability of the issuer may be adjusted (e.g., from 0.5 to 0.3) so as to decrease the liability of the issuer.

If the MCI does not exceed the MCT, the process 1200 proceeds to determine whether security features of payment cards were verified. At block 1208, it is determined whether the merchant utilized an address verification system (AVS) to verify an address (e.g., billing address) of a person claiming to own a credit card. Such determination can be based on the transaction information. If the merchant communicated with an AVS to verify address information (e.g., billing address, zip code) of the card holder, then the merchant's liability is reduced at block 1210.

If the merchant did not verify AVS data at block 1208, then at block 1212, it is determined whether the merchant sent a card verification code such as CVV1, CVV2, or dynamic CVV. The CVVs can be used as a security feature to reduce fraud. A CVV1 is typically encoded on track 2 of the magnetic stripe of a card and automatically retrieved when the card is swiped on a point-of-sale (POS) device in a card present situation. A CVV2 is obtained by a merchant in a card not present situation. A CVV2 can be printed on the back of a card. A dynamic CVV may be generated by a contactless card or chip card.

If it is determined that the merchant did utilize the security feature of CVV, then the merchant's liability is reduced at block 1218. Otherwise, the transaction fraud score of the transaction is compared with a threshold. As discussed, the transaction fraud score is calculated and assigned to every transaction based on information such as previous and/or current transaction information and behavioral data. For a given transaction, a higher transaction score may indicate a higher risk of fraud. If the transaction fraud score exceeds a certain fraud threshold at block 1220, then the issuer's liability can be increased at block 1222. Risky transactions can shift additional liability to an issuer. Otherwise, if the transaction fraud score does not exceed the fraud threshold, then the liability multiplier(s) can be applied to respective parties to determine the final allocation of liabilities. The process 1200 ends at block 1226.

FIG. 13 shows an exemplary process 1300 for processing claims related to authorization errors, in accordance with embodiments. During the process 1200, liabilities among participants of a transaction may be assigned and/or shifted based on various factors such as dispute performance indicators, authorization-related transaction information, and the like. In some embodiments, the process 1300 may be performed based on a predetermined set of rules for handling claims having authorization-related issues. In some embodiments, the process 1300 may retrieve, store, update, or otherwise use data described in FIG. 11.

At block 1302, the authorization process is started. The authorization process can be selected from a plurality of resolution processes or workflows based at least in part on a claim category indicator of a dispute claim. For instance, the claim category indicator may include an alphanumeric string such as “authorization,” a number, or any other suitable representation. The claim category indicator may be selected by a user or determined automatically by the resolution system. Additionally or alternatively, the authorization process can be selected based at least in part on transaction information.

The authorization process can be selected to process a claim with authorization related issues. For instance, the authorization process can be selected to handle a claim arising from a “non-matching account number” situation, where a transaction did not receive authorization and may have been processed using an account number that may not match any account number on the issuer's master file. Or, an original credit (e.g., including a money transfer original credit) may have been processed using an account number that may not match any account number on the issuer's master file.

The authorization process can be selected to handle a claim arising from a “no authorization” situation, where authorization was required for a transaction, but the merchant may not have obtained proper authorization.

The authorization process can also be selected to handle a claim arising from a “declined authorization” situation, where the transaction amount may be incorrect, an addition or transposition error may have been made when calculating the transaction amount, the merchant may have altered the transaction amount after the transaction was completed without the consent of the cardholder, or a transaction may have been processed using an incorrect account number.

The authorization process can also be selected to handle a claim arising from an “expired card” situation, where a merchant may have completed a transaction with a card that expired before the transaction date, and may not have obtained authorization.

The authorization process can be selected to handle a claim arising from a “service code violation” situation, where authorization may not have been obtained for a magnetic-stripe read transaction on a card and the account number of the card is within an account range that requires positive authorization.

At block 1304, it is determined whether an approved authorization record exists for the transaction. If so, at block 1312, the issuer may be held entirely liable (assigned 100% liability) and the acquirer may not be liable (assigned 0% liability). In some other embodiments, the issuer may be assigned a liability that is less than 100% and the acquirer may be assigned a liability that is greater than 0%. In some embodiments, the existence of an approved authorization record shifts additional liability to the issuer. In an embodiment, an initial allocation of default liability (e.g., 50-50) may be assigned to involved parties. The default liability allocation may be shifted among the parties throughout the process 1300 depending on the comparison of various parameters (e.g., transaction information, dispute performance indicators) with threshold values. Optionally, the issuer may be provided a list of possible authorizations.

If it is determined at block 1304 that no approved authorization record exists for the transaction, then the acquirer may be held liable. At block 1306, it is determined whether the issuer claims index (ICI) exceeds a corresponding first threshold such as the issuer claims threshold (ICT). Discussion of ICI and ICT is provided in FIG. 11 above. ICI can be a number or any other suitable representation of a specific issuer's behavior for a given period of time (e.g., past 24 months). The ICT can define a limit for acceptable issuer claim behavior.

If the ICI exceeds the ICT, then at block 1314, the issuer may be assigned 100% liability and the acquirer may be assigned 0% liability. In some embodiments, the issuer's liability may be increased to a value other than 100%, and/or the acquirer's liability may be decreased to values other than 0%. In general, issuers with poor claims ratings (e.g., indicated by a high ICI) may be penalized by receiving varying degrees of additional liability.

If the ICI does not exceed the ICT or first threshold, then at block 1308, it may be determined whether the issuer claims index (ICI) exceeds a corresponding second threshold. The first threshold in decision block 1306 may be higher than the second threshold in block 1308.

If the ICI exceeds the second threshold, then at block 1316, the issuer may be assigned 50% liability and the acquirer may be assigned 50% liability. In some embodiments, the acquirer's liability may be increased and/or the issuer's liability may be decreased to values other than 50%.

If the issuer's claims index does not exceeds the second threshold, then at block 1310, it is determined whether the cardholder's claims index (CCI) exceeds a corresponding threshold such as a cardholder claims threshold (CCT). Discussion of CCI and CCT is provided in FIG. 11 above. CCI can be a number or any other suitable representation of a specific cardholder's behavior for a given period of time (e.g., past 24 months). The CCT can define a limit for acceptable cardholder claim behavior.

If the CCI does not exceed the CCT, then at block 1318, the issuer may be assigned 0% liability and the acquirer may be assigned 100% liability. In some embodiments, the acquirer's liability may be increased to a value other than 100%, and/or the issuer's liability may be decreased to values other than 0%.

If the CCI does exceed the CCT, then at block 1320, another liability could be assigned (e.g., 100% to the issuer). The process 1300 ends at block 1322.

### Collaboration Processes

In some embodiments, the resolution system 150 and/or payment processing network 120 may allow the issuer 130 and acquirer 110 to collaboratively resolve a dispute instead of using a mediator such as the automated resolution module 154. For example, in some embodiments, the resolution system 150 may provide an online venue where the issuer 130 and acquirer 110 can share information, communicate, and come to an agreement as to which parties are liable.

In some embodiments, the collaboration processes may or may not include an automated liability allocation step and/or component. The automated allocation may be based on predetermined collaboration rules governing such the collaboration processes. Such predetermined collaboration rules may be configured to determine allocation of liabilities based on response timeframe of the parties participating in the collaboration process. For instance, in some embodiments, if a party fails to respond to a request for information by a predetermined time period (e.g., 10 days or 25 days), then some or all liability may be shifted to that party. Additionally or alternatively, the predetermined rules may be based other factors such as the parties' dispute performance indicators (representing the parties' dispute histories), transaction information, and the like.

In some embodiments, the collaboration process may be combined with the automated allocation process discussed herein to resolve disputes. For instance, the collaboration process may be used upfront at the beginning of an automated allocation process to obtain additional information. Or, the collaboration process may be used at the back end of an automated allocation process, for example, during the appeal process. Or, the collaboration process may be intertwined with the automated allocation process at various stages. For example, the automated allocation process may use information extracted from the collaboration messages among other information (e.g., transaction information and dispute histories) to reach an allocation decision. The collaboration process may provide input to the automated allocation process and/or use output from the automated allocation process.

FIGS. 14-21 illustrate exemplary collaboration processes that may be implemented by a resolution system, in accordance with embodiments. Any of these processes may be used to implemented steps in the overall resolution process discussed in FIGS. 2 and 3.

FIG. 14 shows an exemplary collaboration process 1400 between an acquirer and an issuer, in accordance with embodiments. At block 1402, the collaboration process is started. The collaboration process can be selected from a plurality of resolution processes or workflows based at least in part on a claim category indicator of a dispute claim and/or on transaction information. In some embodiments, the collaboration process may be initiated by a user (e.g., an issuer) of a claim (e.g., via the online resolution interface). The collaboration process may begin before, during, or after an allocation process described here.

The collaboration process may be selected to handle a claim arising from a “services not provided” or “merchandise not received” situation, where the merchant was either unwilling or unable to provide services (e.g., including prepaid load services). Or, the cardholder or an authorized person did not receive the ordered merchandise at the agreed-upon location or by the agreed-upon date.

The collaboration process may be selected to handle a claim arising from a “credit not processed” situation, where the merchant did not process a credit under circumstances including: merchandise returned, services canceled, canceled timeshare, guaranteed reservation being properly canceled, advanced deposit transaction being properly canceled, original credit not being accepted.

The collaboration process may be selected to handle a claim arising from a “paid by other means” situation, where merchandise or service was received but paid by other means such as cash.

The collaboration process may be selected to handle a claim arising from a “non-receipt of cash or load transaction” situation, where the cardholder participated in the transaction and may not have received cash or load transaction value, or received a partial amount.

The collaboration process may be selected to handle a claim arising from a “not as described” or “defective merchandise” situation, where the cardholder may have received damaged or defective merchandise, merchandise or service did not match what was described on the transaction receipt or other documentation presented at the time of purchase, counterfeit merchandise was received, terms of sale was misrepresented, damaged or defective merchandise was received, merchandise or services received were not the same as merchant's description, or the like.

At block 1404, the issuer may be provided an estimate of its liability 1424, such as a claim assurance indicator (CAI) discussed in FIG. 11. The CAI can indicate an estimated likelihood of claim success for the participant. The participants in a dispute claim may each have their own CAIs determined based on their dispute performance indicators and comparison with the dispute performance indicators of other participants. For example, an entity's CAI may be inversely related to its dispute performance indicator. A higher index may imply a lower CAI. For example, if an issuer may have an ICI that is higher than an ACI of an acquirer, then the issuer's CAI may be lower than the acquirer's CAI. In another example, a higher index may imply a higher CAI. Additionally or alternatively, the CAI may be generated based on previous transaction history and/or current transaction information.

In some embodiments, a CAI may be displayed to a participant using a user interface object on the online resolution interface. The value of the CAI may be indicated by the text, color, size, shape, or other characteristics of the user interface object. For instance, a green CAI indicator may be used to represent a relatively high likelihood of claim success for the participant. A yellow CAI indicator may be used to represent a relatively medium likelihood of claim success for the participant. A red CAI indicator may be used to represent a relatively low likelihood of claim success for the participant.

At block 1406, it is determined whether the issuer chooses to participate in a collaboration process, for example, based on the estimate of liability discussed above. For example, the issuer may indicate his preference via any suitable interface such as via a button, link, or other suitable input control on an online resolution interface. If the issuer chooses not to participate in the collaboration process, then at block 1414, the liability may be automatically assigned to the issuer based on the claim history such as discussed in FIGS. 12-13. In some embodiments, initial or default liabilities (e.g., 50%) may be assigned to the parties (e.g., issuer and acquirer). The initial liabilities may change depending on the respective dispute performance indicators (e.g., claims indicators), transaction information, and the like.

Otherwise, if the issuer chooses to participate in a collaboration process, then at block 1408, one or more requests may be sent for more information 1408. The request may be sent to a merchant and/or an acquirer of the transaction. The request may be sent by the resolution system on behalf of the issuer. The request may be in any suitable format such as an email, a text message, a telephone call, and the like using any suitable communication channels. In some embodiments, the requests may be used to solicit information processed by the requested entities that will aid the resolution of the claim. In some cases, such information may not be readily apparent from the claim information and/or transaction information.

At block 1410, it is determined whether the merchant or the acquirer responds to the request for information. In some embodiments, the requested entities may be given a predetermined period of time (e.g., 10 days) to respond. If there is no response, then at block 1416, the acquirer may be assigned 100% liability and the issuer may be assigned 0% liability. In some other embodiments, the acquirer may be assigned a liability that is less than 100% and/or the issuer may be assigned a liability that is more than 0%.

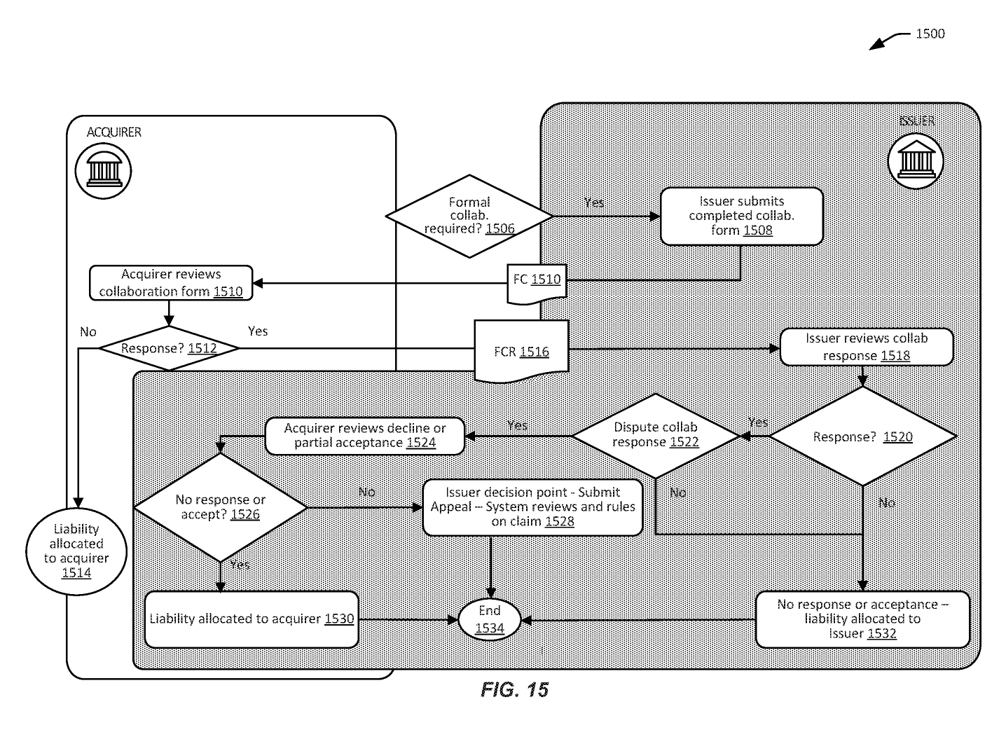

If there is a response, then the parties may use the resolution system to engage in a collaboration process such as discussed in FIGS. 15-21. At block 1412, it is determined whether the dispute is resolved. If the dispute is resolved (e.g., liability allocated), then resolution system may trigger financial settlement based on the resolution results (e.g., liability allocation). If the dispute is not resolved, then at block 1418, the issuer may file a formal claim with the resolution system to resolve the claim collaboratively or automatically. In some embodiments, liability may be assigned automatically using claims history such as discussed in FIGS. 12-13. In other embodiments, liabilities may be assigned collaboratively such as discussed in FIGS. 15-21.

In some embodiments, initial or default liabilities (e.g., 25% and 75%) may be assigned to the parties (e.g., issuer and acquirer). The initial liabilities may change depending on the respective dispute performance indicators (e.g., claims indicators), transaction information, and the like. In some embodiments, the initial liabilities assigned here may be different than the initial liabilities assigned at block 1414 because more information for determining the liability allocation is gained at this point in time than at block 1414. For instance, the acquirer or merchant may have responded with more information. Additional information may also be obtained from third-party databases such as the global merchant repository (GMR) discussed above that contains information about merchants, franchises, and corporations. Based on the additional information, a different initial liability (e.g., not a 50-50 split) may be allocated at the start of the allocation process at block 1420. The process 1400 ends at block 1422.

Participants of a dispute claim can use a resolution system to exchange information and collaboratively resolve a dispute. FIGS. 15-21 illustrate some exemplary processes. In some embodiments, the illustrated processes can be used to implement step 6b of FIG. 1 or block 310 of FIG. 2. In general, blocks illustrated in the “acquirer” box represent steps performed by the acquirer

FIG. 15 shows another exemplary collaboration process 1500 between an issuer and an acquirer, in accordance with embodiments.

At block 1506, it is determined whether formal collaboration is required. In various embodiments, the determination may be based on the claim category, dispute performance indicators, transaction information, and the like. If formal collaboration is determined to be required, then at block 1508, an issuer submits a completed formal collaboration form 1510 (FC). The collaboration form can be provided via an online resolution interface discussed herein and completed by the issuer. Data contained in the collaboration form 1510 can be provided to an acquirer. The collaboration form may include information provided by the issuer about the claim and/or transaction, as well as request for additional information or action from the acquirer. For instance, the collaboration form may include statements from the issuer about why the acquirer should be liable and the acquirer can accept full liability, deny any liability, or accept partial liability.

At block 1510, the acquirer reviews the data in the collaboration form. The collaboration form data can be provided to the acquirer via the online resolution interface. For instance, the acquirer may be allowed to access a dashboard with a link to the data contained in the collaboration form. In another example, the collaboration form may be provided via an email, a text message, a facsimile, or any other suitable communication channel.

The acquirer may be given a predetermined period of time (e.g., 25 days) to respond to the issuer's collaboration form in a formal collaboration response (FCR). The resolution system may start the time period when the issuer's collaboration form is received or viewed by the acquirer. The acquirer may respond via the online resolution interface, email, text message, facsimile, or any other suitable communication channel. At block 1512, it is determined whether the acquirer has responded to the issuer's collaboration form within the predetermined time period. If the acquirer has failed to provide a response in time, then at block 1514, liability may be allocated to the acquirer.

Otherwise, the acquirer may provide a formal collaboration response (FCR) 1516 in time. The formal collaboration response may include an acceptance of full liability, a denial of any liability, or an acceptance of partial liability in response to the formal collaboration form (FC) provided by the issuer. At block 1518, the issuer reviews the collaboration response. The issuer can review the collaboration response via the online resolution interface, in an email or text message, or via any other suitable means.

The issuer may be given a limited amount of time (e.g., 10 days) to provide a response to the acquirer's FCR. At block 1520, it is determined whether the issuer provided a response in time. At block 1532, if the issuer fails to provide a response in time, then liability is allocated to the issuer. In some other embodiments, in the absence of the issuer's response, the issuer is assumed to have accepted the acquirer's response and the liability allocated according to the acquirer's response. For instance, if the acquirer denies any liability, then the issuer is allocated full liability (i.e., 100% liability). If the acquirer accepts full liability, then the issuer is allocated no liability (i.e., 0% liability). If the acquirer accepts partial liability (e.g., 10% liability), then the issuer is allocated the remaining liability (e.g., 90% liability). The process can then end at block 1534.

If the issuer does provide a response, then at block 1522, it is determined whether the issuer disputes the acquirer's collaboration response. If the issuer does not dispute the collaboration response, then full liability may be allocated to the issuer in block 1532. Or, the liability may be allocated to the issuer according to the acquirer's response as discussed above.

If the issuer disputes the acquirer's collaboration response, the acquirer may review the issuer's response (e.g., via the online resolution interface) at block 1524. The acquirer can either accept or decline the issuer's response in block 1526. The acquirer may be given a predetermined period of time (e.g., 10 days) to provide a response to the issuer's response. It is also determined at block 1526 whether the acquirer has failed to file a response within the predetermined time period, or the acquired has filed a response to accept the issuer's response.

If the acquirer has failed to file a response within the predetermined time period, or if the acquired has filed a response to accept the issuer's response, then at block 1530, full liability is allocated to the acquirer, or liability is allocated to the acquirer according to the issuer's response. For instance, if the issuer denies any liability, then the acquirer is allocated full liability (i.e., 100% liability). If the issuer accepts full liability, then the acquirer is allocated no liability (i.e., 0% liability). If the issuer accepts partial liability (e.g., 20% liability), then the acquirer is allocated the remaining liability (e.g., 80% liability).

If the acquirer has filed a response within the predetermined time period to decline or reject the issuer's response, then at block 1528, the issuer can decide whether to submit an appeal with the resolution system and allow the resolution system to automatically assign liabilities to the parties. In some embodiments, the issuer can file an appeal within certain predetermined time (e.g., 45 days) from the filing of the original claim, the submission of the collaboration form at block 1508, or any other suitable point in time. The formal collaboration process 1500 ends at block 1534.

In some cases, the formal collaboration process may be completed within a predetermined maximum time period (e.g., 45 days or 60 days) depending on the various allowable time periods for the parties to respond discussed above. The resolution system can be used to facilitate the entry and exchange of information between the parties, track the state and progress of the collaboration process, and enforce predetermined rules (e.g., response time frame) with respect to the collaboration process so as to allow streamlined resolution of disputes.

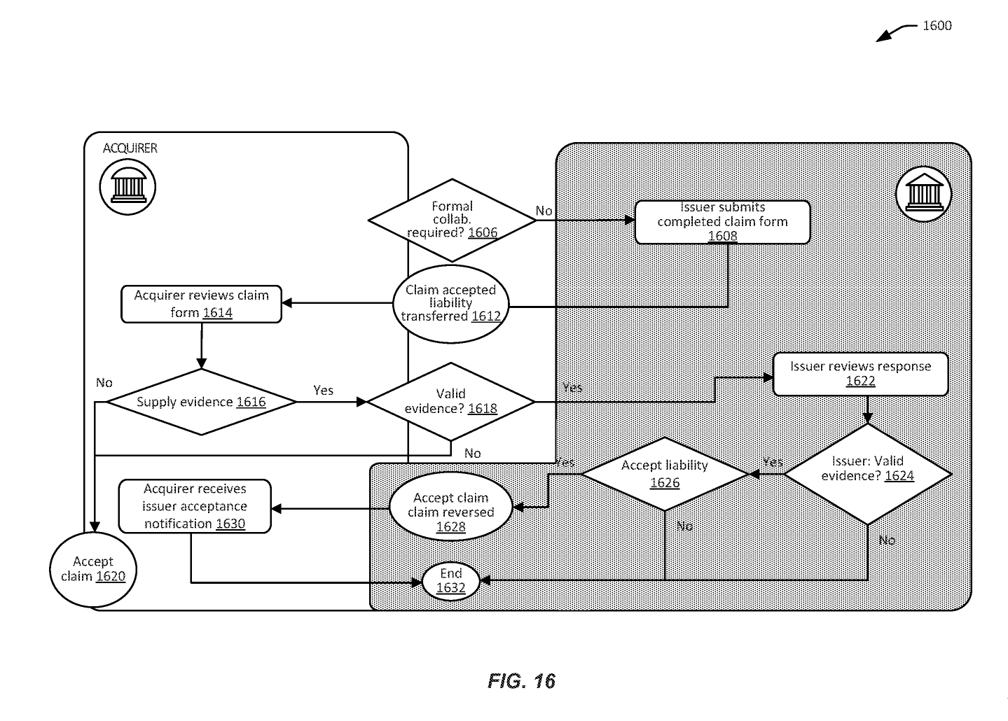

FIG. 16 shows an exemplary collaboration process 1600 where evidence is required to determine a resolution, in accordance with embodiments. The evidence may be required during an appeal for an allocated claim (e.g., a fraud-based claim) or during a regular collaboration process. The collaboration process requiring evidence may be completed within a predetermined maximum time period (e.g., 20 days).

At block 1606, it is determined whether formal collaboration is required. In various embodiments, the determination may be based on the claim category, dispute performance indicators, transaction information, and the like. If formal collaboration is determined to be not required, then at block 1608, an issuer submits a completed claim form. The claim form may be different than the formal collaboration form discussed above in FIG. 15. The claim form can be provided via an online resolution interface discussed herein and completed by the issuer using the online resolution interface. The claim form may include information provided by the issuer about the claim and/or transaction, as well as request for evidence from the acquirer.

At block 1612, the claim based on the claim form is accepted by the resolution system. For example, the acquirer may simply accept liability. Additionally or alternatively, initial liabilities may be allocated between the issuer and the acquirer based on the claim, transaction information, dispute performance indicators, and the like.

At block 1614, the acquirer reviews the claim form. The claim form can be provided to the acquirer via the online resolution interface. For instance, the acquirer may be allowed to access a dashboard with a link to the data contained in the claim form. In another example, the claim form may be provided via an email, a text message, a facsimile, or any other suitable communication channel.

The acquirer may be given a predetermined period of time (e.g., 25 days) to respond to the claim form by providing evidence. The resolution system may start the time period when the issuer's claim form is received or viewed by the acquirer. The acquirer may respond via the online resolution interface, email, text message, facsimile, or any other suitable communication channel. At block 1616, it is determined whether the acquirer has provided evidence within the predetermined time period. If the acquirer has failed to provide evidence within the predetermined time period, then at block 1620, the acquirer is presumed to have accepted the claim.

If the acquirer has provided evidence within the predetermined time period, then at block 1618, it is determined whether the evidence is valid. A predetermined set of validation rules may be applied to the supplied evidence. For instance, the validation rules may be used to validate the format of the evidence and/or authenticate the content of the evidence.

If the evidence is determined to be invalid, then at block 1620, the acquirer is presumed to have accepted the claim. Otherwise, if the evidence is determined to be valid, then at block 1622, the issuer reviews the acquirer response including the evidence. The evidence may be provided to the issuer via the online resolution interface or using any other suitable means. The issuer may be given a predetermined period of time (e.g., 10 days) to respond.

At block 1624, the issuer indicates whether the evidence is valid. If the issuer indicates that the evidence is invalid, then the process 1600 ends at block 1632. If the issuer indicates that the evidence is valid, then at block 1626, the issuer indicates whether the issuer accepts full or partial liability for the claim. In some embodiments, the online resolution interface may prompt the issuer to indicate whether the evidence is valid and/or whether the issuer accepts liability. In some other embodiments, the issuer may provide such indications via other methods such as an email message or a text message.

If the issuer refuses to accept liability at block 1626, then the process 1600 ends at block 1632. If the issuer accepts liability at block 1626, then at block 1628, the reverse or counter claim from the acquirer is determined to have been accepted by the issuer. At block 1630, a notification about the issuer's acceptance of the acquirer's counter claim is sent to the acquirer. The notification may be provided via the online resolution interface, in an email message or a text message, via any other suitable channel. The process 1600 ends at block 1632.

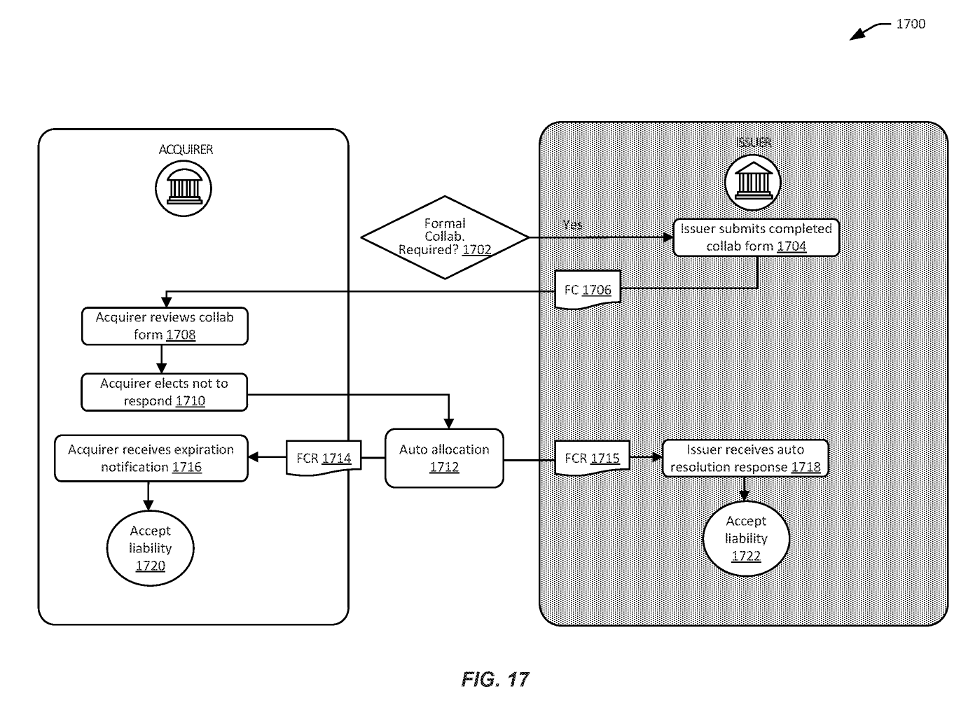

FIG. 17 shows an exemplary collaboration process 1700 where the acquirer elects not to respond to a formal collaboration request from an issuer, in accordance with embodiments. In such embodiments, the resolution system may automatically allocate liabilities among the acquirer and the issuer. In some embodiments, the collaboration process 1700 may be completed within a relatively short maximum time period (e.g., 10 days).

At block 1702, it is determined whether formal collaboration is required. If it is determined that formal collaboration is required, then at block 1704, the issuer submits a completed collaboration form (e.g., via the online resolution interface). The completed collaboration form 1706 is provided to the acquirer. The acquirer may be given a predetermined time period (e.g., 25 days) to review the collaboration form at block 1708. The acquirer may elect not to respond at block 1710.

When a predetermined time period (e.g., 10 days) lapses, in block 1712, the resolution system may proceed to automatically resolve the claim by assigning liabilities to the issuer and the acquirer based on their respective dispute performance indicators, claim information, transaction information, and the like, such as described in FIGS. 12-13. The result of the automatic resolution may be provided to the acquirer and the issuer in a formal collaboration response (FCR) 1714 and a formal collaboration response (FCR) 1715, respectively. The FCR 1714 sent to the acquirer may or may not be the same as the FCR 1715 sent to the issuer. For instance, the FCRs may include the allocation of liabilities for the acquirer and the issuer, as well as a reason for the allocation.

At block 1716, the acquirer receives expiration of the lapse of time period to respond (e.g., 10 days) and the FCR 1714 from the automatic allocation (e.g., via the online resolution interface). In some embodiments, the FCR 1714 includes the notification of the expiration of the lapse of response time period. In other embodiments, the notification about the expiration of lapsed time period may be sent separately from the FCR 1714. At block 1720, the acquirer accepts the allocate liability as indicated in the FCR 1714. The acquirer may optionally appeal the decision using an appeal process such as discussed in FIG. 24.

At block 1718, the issuer receives the FCR 1715 (e.g., via the online resolution interface). At block 1722, the issuer accepts the allocate liability as indicated in the FCR 1715. The issuer may optionally appeal the decision using an appeal process such as discussed in FIG. 24.

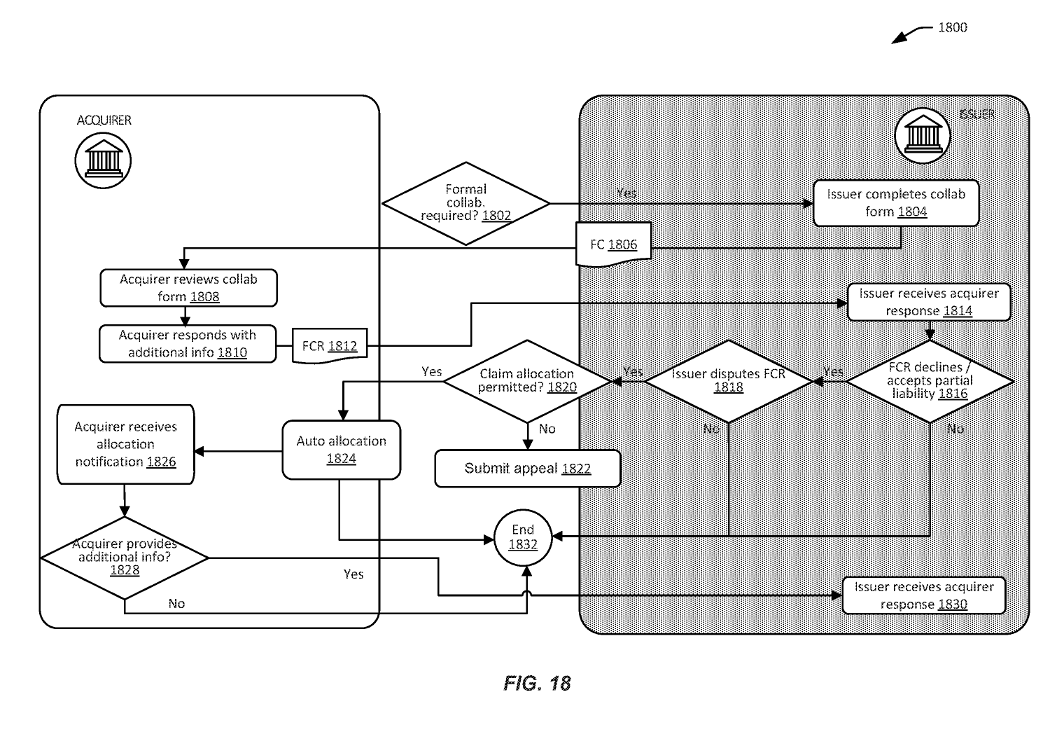

FIG. 18 shows another exemplary collaboration process 1800, in accordance with embodiments of the invention.

At block 1802, it is determined whether formal collaboration is required. In various embodiments, the determination may be based on the claim category, dispute performance indicators, transaction information, and the like. If formal collaboration is determined to be required, then at block 1804, an issuer submits a completed formal collaboration form 1806 (FC). The collaboration form can be provided via an online resolution interface discussed herein and completed by the issuer. Data contained in the collaboration form 1806 can be provided to an acquirer. The collaboration form may include information provided by the issuer about the claim and/or transaction, as well as request for additional information or action from the acquirer. For instance, the collaboration form may include statements from the issuer about why the acquirer should be liable and the acquirer can accept full liability, deny any liability, or accept partial liability.

At block 1808, the acquirer reviews the data in the collaboration form. The collaboration form data can be provided to the acquirer via the online resolution interface. For instance, the acquirer may be allowed to access a dashboard with a link to the data contained in the collaboration form. In another example, the collaboration form may be provided via an email, a text message, a facsimile, or any other suitable communication channel.

The acquirer may be given a predetermined period of time (e.g., 25 days) to respond to the issuer's collaboration form in a formal collaboration response (FCR). The resolution system may start the time period when the issuer's collaboration form is received or viewed by the acquirer. The acquirer may respond via the online resolution interface, email, text message, facsimile, or any other suitable communication channel. At block 1810, the acquirer provides formal collaboration response (FCR 1812) with additional information. The additional information may include evidence supporting the acquirer's acceptance or denial of liability.

The FCR 1812 is provided to the issuer (e.g., via the online resolution interface or another communication channel). At block 1814, the issuer reviews the collaboration response from the acquirer. The issuer can review the collaboration response via the online resolution interface, in an email or text message, or via any other suitable means.

If the FCR indicates that the acquirer accepts liability (as determined at block 1816), then the process 1800 ends at block 1832 and the claim is resolved. If the FCR indicates that the acquirer declines liability or accepts partial liability (as determined at block 1816), then at block 1818, it is determined whether the issuer disputes the FCR. If the issuer does not dispute the acquirer's response, then the process 1800 ends at block 1832 and the claim is resolved. Otherwise, if the issuer does dispute the acquirer's response, then it is determined at block 1820 whether automatic allocation of claim liability is permitted. The determination may be based on the nature of the claim (e.g., claim category), transaction information, dispute performance indicators of the acquirer and the issuer, and the like. The determination may be based on a set of predetermined rules. Certain claims may require additional evidence or collaboration and thus cannot be resolved by an automatic allocation process.

If automatic allocation of claim liability is not permitted, then the issuer may submit an appeal at block 1822. An exemplary appeal process is discussed in FIG. 24. If automatic allocation of claim liability is permitted, then the claim is processed by an automatic allocation process at block 1824. The allocation of liability may be determined on transaction attributes, information contained in the collaboration messages (e.g., FC 1806 and/or FCR 1812), dispute histories or dispute performance indicators of the parties, and/or any other related information.

The result of liability allocation can be provided to the acquirer and/or the issuer. For example, at block 1826, the acquirer receives allocation notification. At block 1828, it is determined whether the acquirer would like to provide addition information. If so, the additional information may be provided to the issuer, who receives and/or review the acquirer's information at block 1830 (e.g., via the online resolution interface or other suitable means). Otherwise, if no additional information is volunteered by the acquirer, then the process 1800 ends at block 1832.

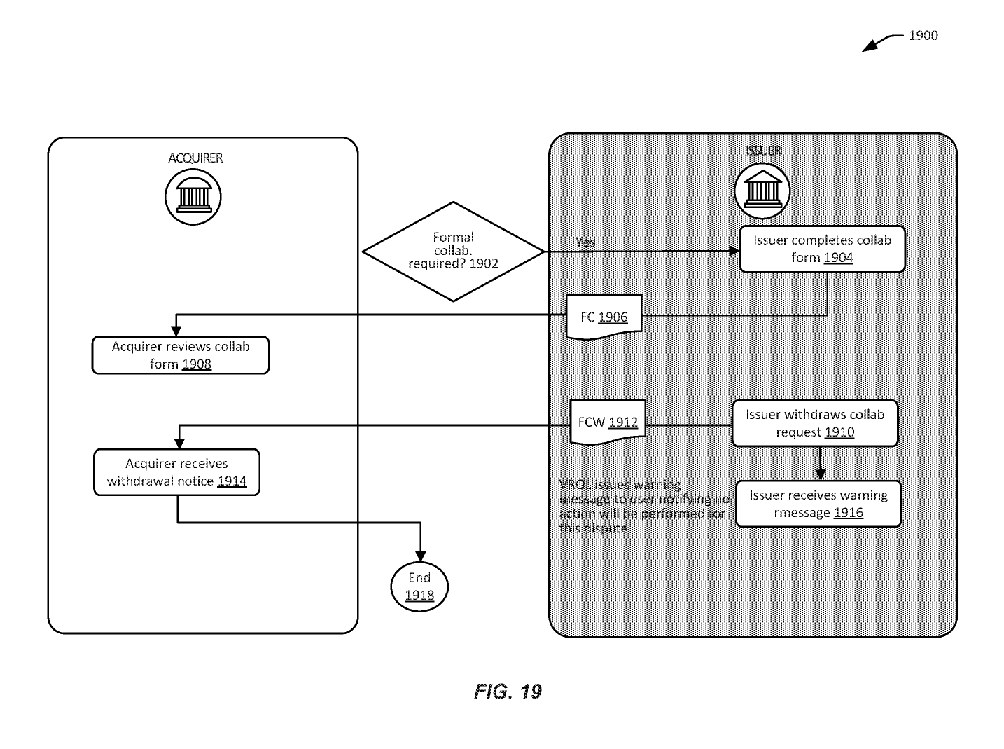

FIG. 19 shows an exemplary collaboration process 1900 where the issuer withdraws the collaboration request, in accordance with embodiments.

At block 1902, it is determined whether formal collaboration is required. In various embodiments, the determination may be based on the claim category, dispute performance indicators, transaction information, and the like. If formal collaboration is determined to be required, then at block 1904, an issuer submits a completed formal collaboration form 1906 (FC). The collaboration form can be provided via an online resolution interface discussed herein and completed by the issuer. Data contained in the collaboration form 1906 can be provided to an acquirer. The collaboration form may include information provided by the issuer about the claim and/or transaction, as well as request for additional information or action from the acquirer. For instance, the collaboration form may include statements from the issuer about why the acquirer should be liable and the acquirer can accept full liability, deny any liability, or accept partial liability.

At block 1908, the acquirer reviews the data in the collaboration form. The collaboration form data can be provided to the acquirer via the online resolution interface. For instance, the acquirer may be allowed to access a dashboard with a link to the data contained in the collaboration form. In another example, the collaboration form may be provided via an email, a text message, a facsimile, or any other suitable communication channel. The acquirer may be given a predetermined period of time (e.g., 25 days) to respond to the issuer's collaboration form in a formal collaboration response (FCR). The resolution system may start the time period when the issuer's collaboration form is received or viewed by the acquirer. The acquirer may be allowed to respond via the online resolution interface, email, text message, facsimile, or any other suitable communication channel.

At block 1910, the issuer withdraws the collaboration request. Rules and constraints may determine when and/or how the issuer may withdraw the collaboration request. For instance, the issuer may not be allowed to withdraw the request until after the time period for the acquirer to respond has lapsed. In another example, the issuer may withdraw the request only within a certain time period (e.g., 10 days) after the submission of the collaboration form. In yet another, the issuer may be allowed to withdraw the request at any time after submission of the collaboration form. In some embodiments, the issuer may only withdraw the request using the online resolution interface, using an email message, a text message, or any other designated methods.

Withdrawal of the collaboration request by the issuer may trigger a warning message to be provided to the issuer. The warning message may notify the issuer the consequence of the withdrawal. For instance, the warning message may inform the issuer that no further action will be performed for this dispute claim due to the withdrawal of the dispute. At block 1916, the issuer receives the warning message.

Withdrawal of the collaboration request by the issuer may trigger a formal collaboration withdrawal (FCW) notice 1912 to be provided to acquirer. The FCW notice 1912 can include information about the claim, the transaction, reason for the withdrawal, or any other relevant information. At block 1914, the acquirer receives the withdrawal notice and the process 1900 ends at block 1918. In some embodiments, the collaboration process 1900 may be completed within a predetermined maximum time period (e.g., 25 days).

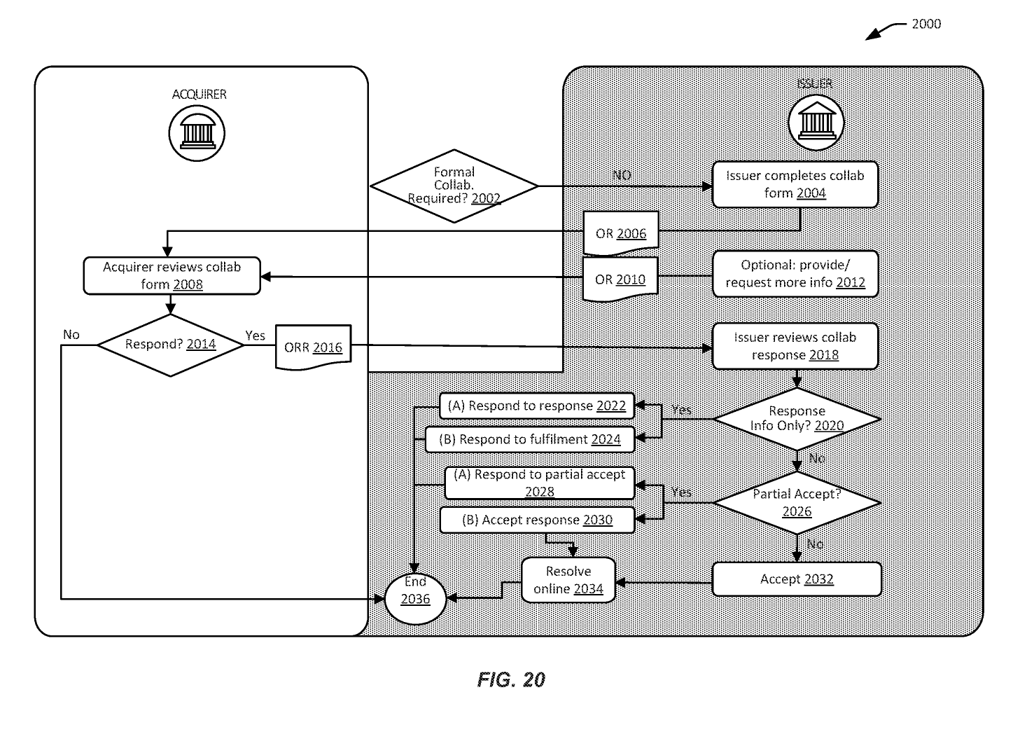

FIG. 20 shows an exemplary collaboration process 2000, in accordance with embodiments. In some embodiments, an issuer can use the collaboration process 2000 to obtain additional information. The collaboration process may be used to obtain information only for certain claim categories and not for other claim categories. For instance, in some embodiments, a claim with a claim category such as “inquiry”, “draft”, and “other” can be used to optionally request information.

At block 2002, it is determined whether formal collaboration is required. In various embodiments, the determination may be based on the claim category, dispute performance indicators, transaction information, and the like. If formal collaboration is determined not to be required, then at block 2004, an issuer submits a collaboration form. The collaboration form may include information provided by the issuer about the claim and/or transaction, as well as request for additional information from the acquirer (OR 2006). For instance, the collaboration form may include statements from the issuer about why the acquirer should be liable and the acquirer can accept full liability, deny any liability, or accept partial liability. The collaboration form can be provided via an online resolution interface discussed herein and completed by the issuer.

At block 2008, the acquirer reviews the collaboration form. The collaboration form data can be provided to the acquirer via the online resolution interface. For instance, the acquirer may be allowed to access a dashboard with a link to the data contained in the collaboration form. In another example, the collaboration form may be provided via an email, a text message, a facsimile, or any other suitable communication channel.

The acquirer may be given a predetermined period of time (e.g., 25 days) to respond to the issuer's collaboration form. The resolution system may start the time period when the issuer's collaboration form is received or viewed by the acquirer. During the predetermined time period for acquirer review, the issuer may optionally follow up to request and/or provide more information (e.g., using the online resolution interface) at block 2012. Such follow-up actions may trigger additional messages (e.g., OR 2010) sent to the acquirer and may reset (e.g., restart) the predetermined time period (e.g., 25 days) for acquirer to review and respond.

At block 2014, the acquirer decides whether to respond to the information requests (e.g., OR 2006 and OR 2010). If the acquirer does not respond within the predetermined time period, then the process 2000 ends at block 2036. If the acquirer does respond within the predetermined time period, then the collaboration response (e.g., ORR 2016) can be provided to the issuer for review. In various embodiments, the acquirer may respond via the online resolution interface, email, text message, facsimile, or any other suitable communication channel.

At block 2018, the issuer reviews the collaboration response from the acquirer. In some cases, the issuer may have a predetermined time period (e.g., 10 days) to respond. At block 2020, it is determined the response from the acquirer includes information only. If so, then the issuer may choose to respond to the acquirer response (block 2022), or respond to fulfilment (block 2024). Otherwise, it is determined at block 2026 whether the acquirer's response includes partial acceptance of liability. If so, then the issuer can respond to the partial acceptance by exchanging more collaboration messages (block 2028) or accept the acquirer's response (block 2030). If the issuer accepts the acquirer's response (block 2030), the resolution system can allocate the liabilities to the issuer and the acquirer according to the partial liability allocation in the acquired response that has also been accepted by the issuer. Liabilities can be transferred between the issuer and the acquirer to achieve the partial liability allocation as agreed by the parties. Data values or data structures representing liabilities for the issuer and the acquirer can be adjusted or modified.

If the acquirer response does not include a partial acceptance and does not include information only, then at block 2032, the issuer can elect to accept the acquirer's response, which may include an acceptance of full liability or decline of any liability. Upon the issuer's acceptance, the liabilities among the parties may be transferred or allocated between the parties by the resolution system accordingly at 2034. For instance, if the acquirer denies any liability in the response and the issuer accepts it, then the acquirer is assigned 0% liability and the issuer is assigned 100%. If the acquirer accepts full liability in the response and the issuer accepts it, then the acquirer is assigned 100% liability and the issuer is assigned 0%. In some embodiments, the issuer may have the option to respond to the acquirer's response instead of accepting the response.

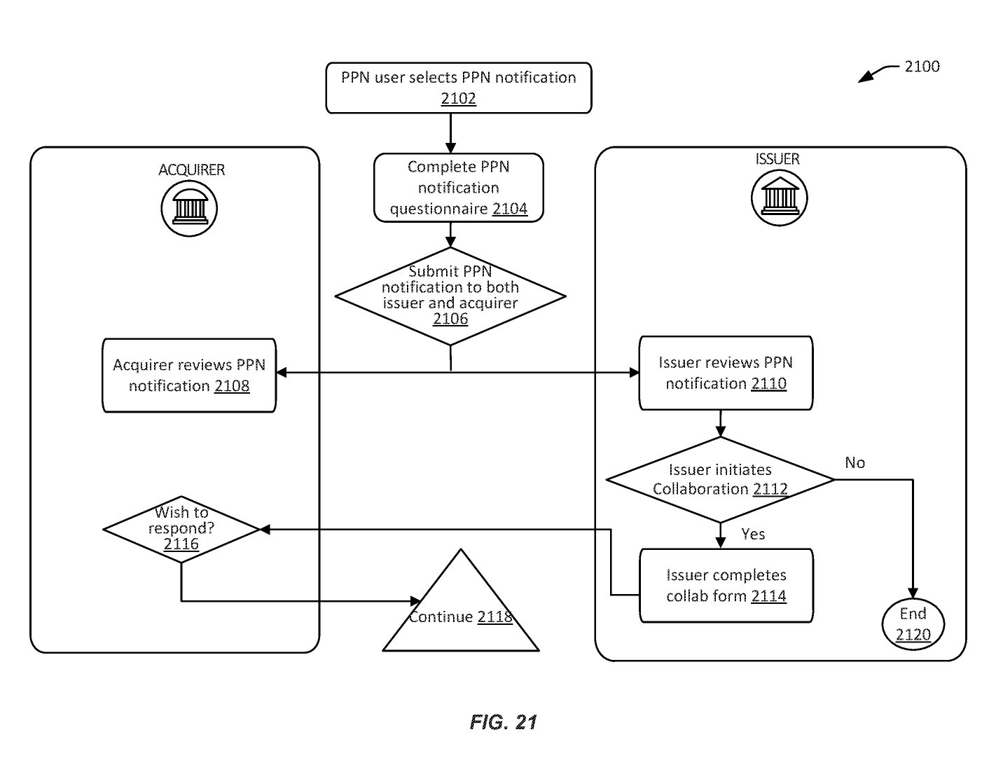

FIG. 21 shows an exemplary collaboration process 2100 for information request as initiated by a payment processing network (e.g., Visa), in accordance with embodiments. At block 2102, a payment processing network (PPN) user can initiate a dispute claim by selecting PPN notification using the resolution system, e.g., via the online resolution interface. At block 2104, the PPN user can complete a PPN notification questionnaire that is provided via the interface. The questionnaire may be used to obtain information regarding the claim such as information identifying a disputed transaction.

At block 2106, the submission of the PPN notification questionnaire may trigger a PPN notification to be provided to both an issuer and an acquirer involved in the claim. At block 2108, the acquirer reviews the PPN notification. At block 2110, the issuer reviews the PPN notification. The issuer and/or the acquirer may be given a predetermined time period (e.g., 25 days) to respond to the notification.

At block 2112, the issuer determine whether to initiate collaboration based on the review of the PPN notification. If the issuer elects not to initiate a collaboration process, then the process 2100 ends at block 2120. Otherwise, if the issuer elects to initiate a collaboration process, then the issuer completes a collaboration form at block 2114. The collaboration form can be provided to the acquirer at block 2118. The rest of the process 2100 may continue at block 2118 similar to those described in FIGS. 15-20.

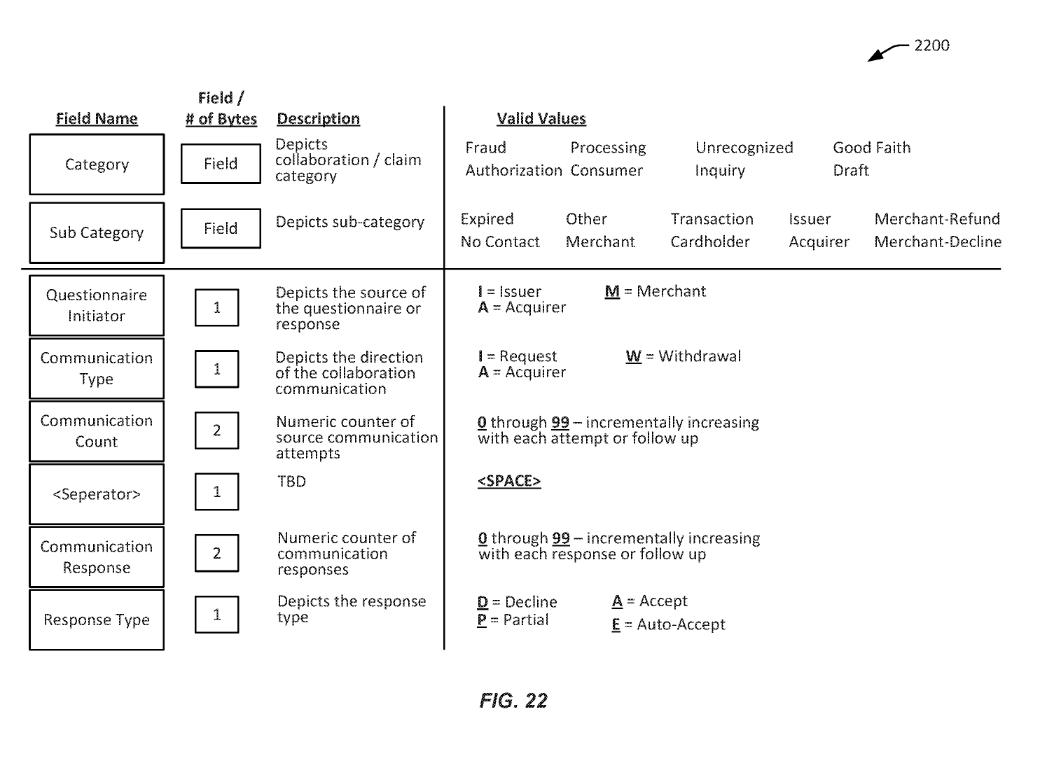

FIG. 22 shows data schema for tracking a collaboration process 2200, in accordance with embodiments. For instance, FIG. 22 lists data schema for a plurality of fields including a field name, field type or size, description, and valid values for each of the fields. The fields can be used to store information about the claims (e.g., fields “category” and “sub category”) or track various aspects of a collaboration process (e.g., fields “questionnaire initiator”, “communication type”, communication count“, “communication response”, and “response type”). In some embodiments, the resolution system may create event entries based on collaboration activities. Data can be logged for intelligence reporting.

### Merchant Access

In some embodiments, the resolution system may provide merchant access so that merchants can participate in aspects of the dispute resolution process such as during the collaboration process and/or during the appeal process. The merchants may be allowed to provide information (e.g., by filling out questionnaires or uploading documents) directly to the resolution system instead of providing the information indirectly, via an acquirer. Access to the resolution system may be configurable by an acquirer.

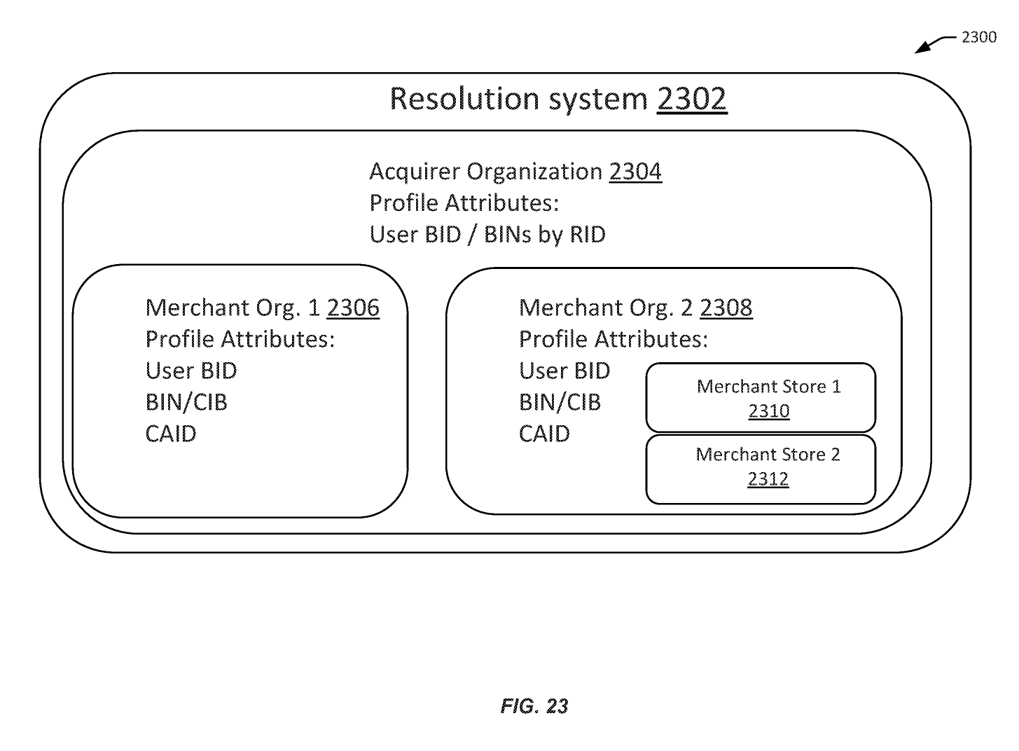

Providing merchant access to aspects of the dispute resolution process can facilitate quicker and fairer resolution of the disputes. The system may allow acquirers to provision access to merchants in order to manage claims and cases. Provisioning access to merchants may include creating a merchant profile in the resolution system. FIG. 23 shows an exemplary merchant profile hierarchy 2300, in accordance with embodiments. The merchant profile hierarchy includes unique data elements that identify the merchant profile.

In some embodiments, certain prerequisites can be satisfied before a merchant profile can be created. For instance, merchants may need to be registered with a Business ID (BID). Merchants users may need to have a valid online ID tied to the business ID. Merchants may need to have at least one nominated administrator. In some embodiments, an acquirer representative can create a merchant profile based on known unique information (“numeric”).

To provision merchant access, a system administrator needs to enroll one or more acquirers by creating the acquirer organization profiles 2304 (also referred to as acquirer profiles) associated with the enrolled acquires within the resolution system 2302. An acquirer profile can have a plurality of profile attributes including a user business ID (BID), a bank identification number (BIN), and the like. In some cases, the BINs may be organized and/or identified by a user's role ID (RID). An enrolled acquirer has access to its own acquirer profile in the resolution system, e.g., via a user interface such as the online resolution interface.

Once an acquirer is enrolled in the resolution system, the acquirer can enroll one or more merchant organizations by creating one or more merchant organization profiles 2306 and 2308 that are linked to the acquirer organization profile 2304 for the acquirer. A merchant organization profile can have a plurality of profile attributes including a user business ID (BID), a bank identification number (BIN), a CIB, a CAID, and the like. An enrolled merchant organization has access to its own merchant organization profile in the resolution system, e.g., via a user interface such as the online resolution interface.

Once an acquirer is enrolled in the resolution system, the acquirer can enroll one or more merchant organizations by creating one or more merchant organization profiles 2306 and 2308 that are linked to the acquirer organization profile 2304 for the acquirer. A merchant organization profile can have a plurality of profile attributes including a user business ID (BID), a bank identification number (BIN), a CIB, a CAID, and the like. An enrolled merchant organization has access to its own merchant organization profile in the resolution system, e.g., via a user interface such as the online resolution interface.

Once a merchant organization is enrolled in the resolution system, the merchant user can enroll one or more merchant stores by creating one or more merchant store profiles 2310 and 2312 that are linked to the merchant organization profile 2308 for the merchant user. A merchant store profile can have a plurality of profile attributes including a user business ID (BID), a bank identification number (BIN), a CAID, and the like. An enrolled merchant store has access to its own merchant store profile in the resolution system, e.g., via a user interface such as the online resolution interface.

In various embodiments, the profile data for acquirer organization, merchant organizations, and merchant stores discussed above can be stored in a data store that is accessible to the resolution system.

Merchant access may enable merchants to interact with the resolution system. For example, the merchants may be allowed to review and/or respond to collaboration cases. Such cases may be queued and assigned by an acquirer, system administrator, or an automated process. For example, a merchant may be allowed to provide information (e.g., by filling out questionnaires or uploading documents) directly to the resolution system instead of providing the information indirectly, via an acquirer. Communications between an acquirer and a merchant may be supported within case handled by the resolution system. Furthermore, activities of incoming claims and liability allocations may be tracked by merchant access.

Appeal Process

An involved party, such as the issuer or acquirer, may appeal after transaction liability has been assigned. In some embodiments, appeal rules may govern aspects of the appeal process. For instance, the rules may govern who can file an appeal or when the appeal can be filed. As an example, only a losing party may be allowed to file an appeal. A losing party may be defined as a party who is assigned the entire liability or more than 50% of the liability. The appeal module may then further investigate the transaction. For example, the resolution system may receive an appeal request, and proceed by gathering more information about the transaction from involved parties. The additional information may be analyzed to provide a more in-depth dispute review process, and the information may be reviewed manually. A new resolution and distribution of liability may result, or the original resolution may be reinforced.

FIG. 24 shows an exemplary appeal process 2400, in accordance with embodiments. The appeal process begins at block 2402, for example, when one of the involved parties is unhappy about a resolution (e.g., liability allocation) of a claim. The party may initiate the appeal process by filing an appeal with the resolution system, e.g., via an online resolution interface or using any other means. In some cases, the appeal process may be initiated by a party within certain a predetermined time period, such as within 10 daysof the party's receiving the assigned liability.

At block 2404, the resolution system may prompt the appealing party and/or the other parties in the claim to submit compelling evidence. The resolution system may share some or all the submitted evidence to with the involved parties. In some cases, the resolution system enforces certain constraints related to the submission of the evidence. For instance, the evidence may be submitted only within a certain time period (e.g., within 10 days of the filing of the appeal).

At block 2406, it is determined whether the appealing party decides to surrender given the submitted evidence. If so, then the appeal process ends at block 2412. Otherwise, the case details and compelling evidence may be reviewed by one or more people, such as a global arbitration and compliance committee. The time of the case review may be limited by a predetermined limit (e.g., 10 days). At block 2410, a final ruling may be issued based on the case review at block 2408. In some embodiments, the final ruling of the case may be provided in notification messages to the parties involved. The various timing constraints associated with some or all steps of the appeal process help to shorten and streamline the process.

Embodiments of the invention have a number of advantages. For example, a resolution system 150 that can automatically resolve a transaction dispute by applying standard rules and regulations to known transaction information and/or dispute histories enables a simple, fast, transparent, inexpensive, fair, and scalable resolution process. Little or no communication may be required from involved parties, so the resolution process may be less expensive for everyone, and minimal time is spent gathering information. When an issuer 130 or acquirer 110, for example, wishes to file a transaction dispute claim, they may simply specify which transaction, as the resolution system 150 may already have all necessary information for the resolution process. In some embodiments, little or no manual labor is used, as many disputes can be resolved by automated systems. Rules and regulations can be transparent, so issuers, acquirers, consumers, and merchants can know what to expect, and can take positive action to improve their transaction practices and reduce their liability. Also, there can be any number of rules and regulations, so any relevant transaction information can be considered and evaluated, including transaction information that previously has not been gathered or used. Transaction liability can be divided, instead of only one party being found responsible, so costs can be fairly distributed. Dispute histories/indices can be evaluated and considered when determining liability, so abuse of the dispute resolution process can be mitigated. Even further, allowing parties to collaboratively resolve disputes and avoid the use of a mediator promotes positive communication and mutual resolution satisfaction, and can save time and resources.

A computer system that may be used to implement any of the entities or components described above. A computer system may include subsystems interconnected via a system bus. Subsystems include a printer, keyboard, fixed disk, and monitor, which is coupled to display adapter. Peripherals and input/output (I/O) devices, which couple to I/O controller, can be connected to the computer system by any number of means known in the art, such as a serial port. For example, a serial port or an external interface can be used to connect the computer apparatus to a wide area network such as the Internet, a mouse input device, or a scanner. The interconnection via system bus allows a central processor to communicate with each subsystem and to control the execution of instructions from system memory or the fixed disk, as well as the exchange of information between subsystems. The system memory and/or the fixed disk may embody a computer-readable medium.

As described, the inventive service may involve implementing one or more functions, processes, operations, or method steps. In some embodiments, the functions, processes, operations, or method steps may be implemented as a result of the execution of a set of instructions or software code by a suitably-programmed computing device, microprocessor, data processor, or the like. The set of instructions or software code may be stored in a memory or other form of data storage element which is accessed by the computing device, microprocessor, etc. In other embodiments, the functions, processes, operations, or method steps may be implemented by firmware or a dedicated processor, integrated circuit, etc.

Any of the software components or functions described in this application may be implemented as software code to be executed by a processor using any suitable computer language such as, for example, Java, C++, or Perl using, for example, conventional or object-oriented techniques. The software code may be stored as a series of instructions, or commands on a computer-readable medium, such as a random access memory (RAM), a read-only memory (ROM), a magnetic medium such as a hard-drive or a floppy disk, or an optical medium such as a CD-ROM. Any such computer-readable medium may reside on or within a single computational apparatus, and may be present on or within different computational apparatuses within a system or network.

While certain exemplary embodiments have been described in detail and shown in the accompanying drawings, it is to be understood that such embodiments are merely illustrative of and not intended to be restrictive of the broad invention, and that this invention is not to be limited to the specific arrangements and constructions shown and described, since various other modifications may occur to those with ordinary skill in the art.

As used herein, the use of “a”, “an” or “the” is intended to mean “at least one”, unless specifically indicated to the contrary.

What is claimed is:

1. A computer-implemented computer, comprising:
receiving, by a computer, a dispute claim regarding a disputed transaction and transaction information about the disputed transaction;
obtaining, by the computer, a plurality of dispute performance indicators respectively associated with a plurality of parties of the disputed transaction, the dispute performance indicators generated based at least in part on dispute histories respectively associated with the parties; and
automatically determining, by the computer, an allocation of liabilities among the plurality of parties based at least in part on the transaction information and the dispute performance indicators.

2. The method of claim 1, wherein the dispute claim is associated with a claim category and the dispute claim is processed by the computer based at least in part on the claim category.

3. The method of claim 1, wherein automatically determining the allocation of liabilities comprises applying a set of predetermined allocation rules to the transaction information and the plurality of dispute performance indicators.

4. The method of claim 1, further comprising validating, by the computer, the dispute claim based at least in part on the transaction information prior to automatically determining the allocation of liabilities.

5. The method of claim 4, wherein validating the dispute claim comprises applying a set of predetermined validation rules to the transaction information.

6. A computer system, comprising:
a memory that stores one or more computer-executable instructions; and
a processor configured to access the memory and execute the computer-executable instructions to implement a method comprising:
receiving a dispute claim regarding a disputed transaction and transaction information about the disputed transaction;
obtaining a plurality of dispute performance indicators respectively associated with a plurality of parties of the disputed transaction, the dispute performance indicators generated based at least in part on dispute histories respectively associated with the parties; and
automatically determining an allocation of liabilities among the plurality of parties based at least in part on the transaction information and the dispute performance indicators.

7. The computer system of claim 6, wherein the dispute claim is associated with a claim category and the dispute claim is processed by the computer based at least in part on the claim category.

8. The computer system of claim 6, wherein automatically determining the allocation of liabilities comprises applying a set of predetermined allocation rules to the transaction information and the plurality of dispute performance indicators.

9. The computer system of claim 6, wherein the method further comprises validating the dispute claim based at least in part on the transaction information prior to automatically determining the allocation of liabilities.

10. The computer system of claim 9, wherein validating the dispute claim comprises applying a set of predetermined validation rules to the transaction information.

11. A computer-implemented method, comprising:
receiving, a computer, a dispute claim regarding a disputed transaction, the dispute transaction associated with a claim category;
selecting, by the computer, a resolution process from a plurality of predetermined processes comprising at least an automated liability allocation process and a collaborative dispute resolution process based at least in part on the claim category; and
processing, by the computer, the dispute claim using the selected resolution process to determine an allocation of liabilities among at least two parties associated with the dispute claim.

12. The computer-implemented method of claim 11, wherein the selecting the resolution process comprising selecting the automated liability allocation process when the claim category indicates fraud or authorization related issues and selecting the collaborative dispute resolution process when the claim category indicates processing related issues.

13. The computer-implemented method of claim 12, wherein selecting the automated liability allocation comprises selecting a first automated liability allocation process when the claim category is indicates fraud related issues and selecting a second automated liability allocation process when the claim category is indicates authorization related issues.

14. The computer-implemented method of claim 11, wherein determining the allocation of liabilities among the at least two parties comprises:
comparing a dispute performance indicator associated with one party of the at least two parties with a threshold value, the dispute performance indicator generated based at least in part on dispute history associated with the party; and
adjusting the allocation of liabilities based at least in part on the comparison.

15. The computer-implemented method of claim 11, further comprising selecting the resolution process based at least in part on transaction information of the disputed transaction.

16. A computer system, comprising:
a memory that stores one or more computer-executable instructions; and
a processor configured to access the memory and execute the computer-executable instructions to implement a method comprising:
receiving, a computer, a dispute claim regarding a disputed transaction, the dispute transaction associated with a claim category;
selecting, by the computer, a resolution process from a plurality of predetermined processes comprising at least an automated liability allocation process and a collaborative dispute resolution process based at least in part on the claim category; and
processing the dispute claim using the selected resolution process to determine an allocation of liabilities among at least two parties associated with the dispute claim.

17. The computer system of claim 16, wherein the selecting the resolution process comprising selecting the automated liability allocation process when the claim category indicates fraud or authorization related issues and selecting the collaborative dispute resolution process when the claim category indicates processing related issues.

18. The computer system of claim 17, wherein selecting the automated liability allocation comprises selecting a first automated liability allocation process when the claim category is indicates fraud related issues and selecting a second automated liability allocation process when the claim category is indicates authorization related issues.

19. The computer system of claim 16, wherein determining the allocation of liabilities among the at least two parties comprises:
comparing a dispute performance indicator associated with one party of the at least two parties with a threshold value, the dispute performance indicator generated based at least in part on dispute history associated with the party; and
adjusting the allocation of liabilities based at least in part on the comparison.

20. The computer system of claim 16, further comprising selecting the resolution process based at least in part on transaction information of the disputed transaction.
